(19) United States
(12) Patent Application Publication
(10) Pub. No.: US 2024/0019540 A1
(43) Pub. Date: Jan. 18, 2024

(54) DATA TRANSMISSION METHOD AND APPARATUS

(71) Applicant: HUAWEI TECHNOLOGIES CO., LTD., Shenzhen (CN)

(72) Inventors: Rui DU, Shenzhen (CN); Xiao HAN, Shenzhen (CN); Chenchen LIU, Shenzhen (CN); Meihong ZHANG, Shenzhen (CN); Wei LIN, Shenzhen (CN); Xun YANG, Shenzhen (CN); Zhengchun ZHOU, Chengdu (CN); Xianfu LEI, Chengdu (CN); Xiaohu TANG, Chengdu (CN)

(21) Appl. No.: 18/338,965

(22) Filed: Jun. 21, 2023

Related U.S. Application Data
(63) Continuation of application No. PCT/CN2021/118480, filed on Sep. 15, 2021.

(30) Foreign Application Priority Data
Dec. 23, 2020 (CN) 202011540238.5

(51) Int. Cl. G01S 7/40; G01S 7/00

(52) U.S. Cl. CPC G01S 7/40; G01S 7/006

(57) ABSTRACT

A data transmission method. A physical layer protocol data unit (PPDU) is generated. The PPDU includes a training field. The training field includes a sequence used for target sensing. The PPDU is sent.

### CROSS-REFERENCE TO RELATED APPLICATION

This application is a continuation of International Application No. PCT/CN2021/118480, filed on Sep. 15, 2021, which claims priority to Chinese Patent Application No. 202011540238.5, filed on Dec. 23, 2020. The disclosure of the aforementioned applications are hereby incorporated by reference in their entireties.

### STATEMENT OF JOINT RESEARCH AGREEMENT

The subject matter and the claimed invention were made by or on the behalf of Southwest Jiaotong University, of West Park of High-tech Zone, Chengdu, Sichuan, P.R. China and Huawei Technologies Co., Ltd., of Shenzhen, Guangdong Province, P.R. China, under a joint research agreement titled “Future Generation 60 GHz WiFi PHY Technology Research”. The joint research agreement was in effect on or before the claimed invention was made, and that the claimed invention was made as a result of activities undertaken within the scope of the joint research agreement.

### BACKGROUND

Wireless local area network (WLAN, Wireless Local Area Network) sensing is a technology that uses a wireless signal to sense a target. The technology is based on an ability to measure and sample an environment by using radio. Each communication path between two physical devices provides an opportunity to extract information about surroundings of the two physical devices. WLAN devices are increasingly widely used due to advantages such as no cabling, high mobility, and a high transmission rate. Therefore, WLAN sensing (WLAN sensing) based on a WLAN standard has very wide application prospects.

Existing IEEE 802.11 series standards include mainstream low frequency band (for example, 2.4 GHz and 5 GHz) related standards (for example, 802.11n, 802.11ac, 802.11ax, and the like) and high frequency band (for example, 60 GHz) related standards (for example, 802.11ad and 802.11ay). WLAN sensing in the conventional technology usually performs target sensing based on the foregoing existing standards.

A high frequency band (for example, 60 GHz) signal has a short wavelength, is sensitive to a moving object, has a large transmission bandwidth, and has high distance resolution. Therefore, the high frequency band signal has a good target sensing advantage. However, sequences used in the existing high frequency band related standards are designed for optimal communication, and therefore optimal sensing cannot be implemented.

### SUMMARY

Embodiments described herein provide a data transmission method and apparatus, to perform target sensing and improve sensing performance.

According to a first aspect, at least one embodiment a data transmission method, including:
generating a physical layer protocol data unit PPDU, where the PPDU includes a training field, and the training field includes a sequence used for target sensing; and
sending the PPDU.

Based on the foregoing embodiment, the sequence is optimized and designed, so that the sequence is applied to an existing high frequency band related standard, and target sensing with high performance is performed.

In at least one embodiment of the first aspect, the sequence used for target sensing is obtained based on a binary sequence pair, an Alamouti matrix, and a Prouhet-Thue-Morse PTM sequence, where the Alamouti matrix includes:

$$A 0 = [ \begin{matrix}x , & - \tilde{y} \\ y , & \tilde{x}\end{matrix} ] and A 1 = [ \begin{matrix}- \tilde{y} , & - x \\ \tilde{x} , & - y\end{matrix} ] .$$

In response to x and y being the binary sequence pair, \tilde{x} and \tilde{y} are respectively inverted complex conjugates of x and y, A0 corresponds to 0 in the PTM sequence, A1 corresponds to 1 in the PTM sequence, a length of the PTM sequence is 2^{M+1}, and M is an integer greater than 0.

Based on the foregoing embodiment, the sequence that is obtained based on the binary sequence pair, the Alamouti matrix, and the Prouhet-Thue-Morse PTM sequence and that is used for target sensing is a variable-length sequence with high Doppler tolerance. The sequence is applied to the existing high frequency band related standard to perform target sensing. In this way, sensing performance is improved, and a good sensing function is provided.

M has different values. Different values of M correspond to sequences of different lengths used for sensing. A larger value of M indicates a longer correspondingly generated sequence used for target sensing, less interference between sequences in response to the sequence being used for sensing, and better sensing performance Because sending time of the sequence used for target sensing is to be less than maximum accumulated time of the sequence used for sensing, optionally, a value of M is an integer ranging from 1 to 5. Sensing performance of a sequence that has a corresponding length within the value range and that is used for target sensing is good. However, a value range of M is not limited thereto.

In at least one embodiment of the first aspect, in response to M=1, sequences used for target sensing are S_{Vm11} and S_{Hm12}, where S_{Vm11} and S_{Hm12} are:

S_{Vm11}=[x,−\tilde{y},−\tilde{y},−x,−\tilde{y},−x,x,−\tilde{y}]; and

S_{Hm12}=[y,\tilde{x},\tilde{x},−y,\tilde{x},−y,y,\tilde{x}].

In at least one embodiment of the first aspect, in response to M=2, sequences used for target sensing are S_{Vm21} and S_{Hm22}, where S_{Vm21} and S_{Hm22} are:

S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and

S_{Hm22}=[y,\tilde{x},\tilde{x},−y,\tilde{x},−y,y,\tilde{x},\tilde{x},−y,y,\tilde{x},y,\tilde{x},\tilde{x},−y].

In at least one embodiment of the first aspect, in response to M=3, sequences used for target sensing are S_{Vm31} and S_{Hm32}, where S_{Vm31} and S_{Hm32} are:

S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and

S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

In at least one embodiment of the first aspect, a sequence length of the binary sequence pair includes any one of the following: 256 bits, 512 bits, 1024 bits, and 2048 bits.

Based on the foregoing embodiment, the binary sequence pair is used as a base sequence used for generating a sensing sequence, a local area has a low autocorrelation and a low cross-correlation, and the sensing sequence generated based on the binary sequence pair with the low autocorrelation and the low cross-correlation has high Doppler tolerance and good target sensing performance.

In at least one embodiment of the first aspect, in response to a sequence length of the binary sequence pair being the 256 bits, sequences corresponding to the binary sequence pair are:
Sn2561 and Sn2562, where for specific forms of Sn2561 and Sn2562, refer to description of embodiments.

In at least one embodiment of the first aspect, in response to a sequence length of the binary sequence pair being the 512 bits, sequences corresponding to the binary sequence pair are:
Sn5121 and Sn5122, where for specific forms of Sn5121 and Sn5122, refer to description of embodiments.

In at least one embodiment of the first aspect, in response to a sequence length of the binary sequence pair being 1024, sequences corresponding to the binary sequence pair are:
Sn10241 and Sn10242, where for specific forms of Sn10241 and Sn10242, refer to description of embodiments.

In at least one embodiment of the first aspect, in response to a sequence length of the binary sequence pair being 2048, sequences corresponding to the binary sequence pair are:
Sn20481 and Sn20482, where for specific forms of Sn20481 and Sn20482, refer to description of embodiments.

According to a second aspect, at least one embodiment a data transmission method, including:
receiving a physical layer protocol data unit PPDU, where the PPDU includes a training field, and the training field includes a sequence used for target sensing; and
performing target sensing based on the sequence used for target sensing.

Based on the foregoing embodiment, the sequence is optimized and designed, so that the sequence is applied to an existing high frequency band related standard, and target sensing with high performance is performed.

In at least one embodiment of the second aspect, the sequence used for target sensing is obtained based on a binary sequence pair, an Alamouti matrix, and a Prouhet-Thue-Morse PTM sequence, where the Alamouti matrix includes:

$$A 0 = [ \begin{matrix}x , & - \tilde{y} \\ y , & \tilde{x}\end{matrix} ] and A 1 = [ \begin{matrix}- \tilde{y} , & - x \\ \tilde{x} , & - y\end{matrix} ] .$$

In response to x and y being the binary sequence pair, \tilde{x} and \tilde{y} are respectively inverted complex conjugates of x and y, A0 corresponds to 0 in the PTM sequence, A1 corresponds to 1 in the PTM sequence, a length of the PTM sequence is 2^{M+1} and M is an integer greater than 0.

Based on the foregoing embodiment, the sequence that is obtained based on the binary sequence pair, the Alamouti matrix, and the Prouhet-Thue-Morse PTM sequence and that is used for target sensing is a variable-length sequence with high Doppler tolerance. The sequence is applied to the existing high frequency band related standard to perform target sensing. In this way, sensing performance is improved, and a good sensing function is provided. M has different values. Different values of M correspond to sequences of different lengths used for sensing. A larger value of M indicates a longer correspondingly generated sequence used for target sensing, less interference of the sequence used for target sensing during target sensing, and better sensing performance Because sending time of the sequence used for target sensing is to be less than maximum accumulated time of the sequence used for sensing, optionally, a value of M is an integer ranging from 1 to 5. Sensing performance of a sequence that has a corresponding length within the value range and that is used for target sensing is good. A value range of M is not limited thereto.

In at least one embodiment of the second aspect, in response to M=1, sequences used for target sensing are S_{Vm11} and S_{Hm12}, where S_{Vm11} and S_{Hm12} are:

S_{Vm11}=[x,−\tilde{y},−\tilde{y},−x,−\tilde{y},−x,x,−\tilde{y}]; and

S_{Hm12}=[y,\tilde{x},\tilde{x},−y,\tilde{x},−y,y,\tilde{x}].

In at least one embodiment of the second aspect, in response to M=2, sequences used for target sensing are S_{Vm21} and S_{Hm22}, where S_{Vm21} and S_{Hm22} are:

S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and

S_{Hm22}=[y,\tilde{x},\tilde{x},−y,\tilde{x},−y,y,\tilde{x},\tilde{x},−y,y,\tilde{x},y,\tilde{x},\tilde{x},−y].

In at least one embodiment of the second aspect, in response to M=3, sequences used for target sensing are S_{Vm31} and S_{Hm32}, where S_{Vm31} and S_{Hm32} are:

S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and

S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

In at least one embodiment of the second aspect, a sequence length of the binary sequence pair includes any one of the following: 256 bits, 512 bits, 1024 bits, and 2048 bits.

Based on the foregoing embodiment, the binary sequence pair is used as a base sequence used for generating a sensing sequence, a design principle of the binary sequence pair is that a local area has a low autocorrelation and a low cross-correlation, and the sensing sequence generated based on the binary sequence pair with the low autocorrelation and the low cross-correlation has high Doppler tolerance and good target sensing performance.

In at least one embodiment of the second aspect, in response to a length of the binary sequence pair being the 256 bits, sequences corresponding to the binary sequence pair are:
Sn2561 and Sn2562, where for specific forms of Sn2561 and Sn2562, refer to description of embodiments.

In at least one embodiment of the second aspect, in response to a length of the binary sequence pair being the 512 bits, sequences corresponding to the binary sequence pair are:
Sn5121 and Sn5122, where for specific forms of Sn5121 and Sn5122, refer to description of embodiments.

In at least one embodiment of the second aspect, in response to a length of the binary sequence pair being 1024, sequences corresponding to the binary sequence pair are:
Sn10241 and Sn10242, where for specific forms of Sn10241 and Sn10242, refer to description of embodiments.

In at least one embodiment of the second aspect, in response to a length of the binary sequence pair being 2048, sequences corresponding to the binary sequence pair are:
Sn20481 and Sn20482, where for specific forms of Sn20481 and Sn20482, refer to description of embodiments.

A third aspect of at least one embodiment a data transmission apparatus, where the data transmission apparatus is configured to perform any implementation of the first aspect.

A fourth aspect of at least one embodiment a data transmission apparatus, where the data transmission apparatus is configured to perform any implementation of the second aspect.

A fifth aspect of at least one embodiment a data transmission apparatus, including a processor and a transceiver.

The processor is configured to generate a physical layer protocol data unit PPDU, where the PPDU includes a training field, and the training field includes a sequence used for target sensing.

The transceiver is configured to send the physical layer protocol data unit PPDU.

A sixth aspect of at least one embodiment a data transmission apparatus, including a processor and a transceiver.

The transceiver is configured to receive a physical layer protocol data unit PPDU, where the PPDU includes a training field, and the training field includes a sequence used for target sensing.

The processor is configured to perform target sensing based on the sequence used for target sensing.

A seventh aspect of at least one embodiment a data transmission apparatus, including a processing circuit and an output interface.

The processing circuit is configured to generate a physical layer protocol data unit PPDU, where the PPDU includes a training field, and the training field includes a sequence used for target sensing.

The output interface is configured to output the PPDU.

An eighth aspect of at least one embodiment a data transmission apparatus, including a processing circuit and an input interface.

The input interface is configured to input a physical layer protocol data unit PPDU, where the PPDU includes a training field, and the training field includes a sequence used for target sensing.

The processing circuit is configured to perform target sensing based on the sequence used for target sensing.

A ninth aspect of at least one embodiment a computer-readable storage medium, configured to store a computer program, where the computer program includes instructions used to perform a method in the first aspect or the second aspect.

A tenth aspect of at least one embodiment a computer program product, including instructions used to perform a method in the first aspect or the second aspect.

### BRIEF DESCRIPTION OF DRAWINGS

The following further describes features of at least one embodiment and a relationship between the features with reference to the accompanying drawings. The accompanying drawings are all examples, and some features are not shown in actual proportions. In addition, some accompanying drawings are capable of omitting features that are commonly used in the field of embodiments described here and that are not necessary for embodiments described herein, or additionally show features that are not necessary for embodiments described herein. A combination of the features shown in the accompanying drawings is not intended to limit embodiments described herein. In addition, content referred to by a same reference numeral is also the same. The accompanying drawings are described as follows:

FIG. 1 is a schematic flowchart of a data transmission method according to at least one embodiment;

FIG. 2 is a transmission and reception diagram of a full polarization radar system;

FIG. 3A is a frame structure of 802.11ad according to at least one embodiment;

FIG. 3B is a frame structure of 802.11ay according to at least one embodiment;

FIG. 4 is a schematic flowchart of a method for generating a binary sequence pair according to at least one embodiment;

FIG. 5 is a flowchart of iteratively updating a binary sequence pair by using a coordinate descent algorithm according to at least one embodiment;

FIG. 6 is a schematic flowchart of a method for generating a binary sequence pair according to at least one embodiment;

FIG. 7A and FIG. 7B are a schematic flowchart of a specific implementation of iteratively updating a binary sequence pair by using a coordinate descent algorithm in a method for generating a binary sequence pair according to at least one embodiment;

FIG. 8 is a schematic diagram of a model of a self-ambiguity function of a sequence used for sensing according to at least one embodiment;

FIG. 9 is a schematic diagram of a model of a mutual ambiguity function of a sequence used for sensing according to at least one embodiment;

FIG. 10 is a schematic diagram of still another model of a self-ambiguity function of a sequence used for sensing according to at least one embodiment;

FIG. 11 is a schematic diagram of still another model of a mutual ambiguity function of a sequence used for sensing according to at least one embodiment;

FIG. 12 is a schematic diagram of still another model of a self-ambiguity function of a sequence used for sensing according to at least one embodiment;

FIG. 13 is a schematic diagram of still another model of a mutual ambiguity function of a sequence used for sensing according to at least one embodiment;

FIG. 14 is a schematic diagram of a structure of a data transmission apparatus applied to a transmitting end according to at least one embodiment;

FIG. 15 is a schematic diagram of a structure of a data transmission apparatus applied to a receiving end according to at least one embodiment; and

FIG. 16 is a schematic diagram of a structure of a communication system according to at least one embodiment.

### DESCRIPTION OF EMBODIMENTS

Terms such as “first, second, third, and the like” or module A, module B, module C, and the like used herein and in the claims are merely used to distinguish between similar objects, and do not represent a specific order of objects. Specific orders or priorities is interchanged in response to being allowed, so that at least one embodiment described herein is implemented in an order other than those shown or described herein.

In the following description, involved reference numerals such as S110 and S120 that indicate steps do not necessarily indicate that the steps are to be performed based on the order, and consecutive steps is interchanged in response to being allowed, or is performed simultaneously.

The terms “include” and “comprise” used herein and in the claims should not be construed as being limited to the content listed below, and another element or step is not excluded. Therefore, the terms “include” and “comprise” should be interpreted as specifying the presence of the stated features, integers, steps, or components, but does not preclude the presence or addition of one or more other features, integers, steps, components, and groups thereof. Therefore, an expression “a device including/comprising apparatuses A and B” should not be limited to a device including/comprising only the components A and B.

“One embodiment” or “an embodiment” mentioned herein means that particular features, structures, or characteristics related to the embodiment are included in at least one embodiment. Therefore, terms such as “in one embodiment” or “in an embodiment” throughout do not necessarily refer to a same embodiment, but refer to a same embodiment. In addition, in one or more embodiments, particular features, structures, or characteristics is combined in any proper manner, as is apparent to a person of ordinary skill in the art from the present disclosure.

Unless otherwise defined, all technical and scientific terms used in embodiments described herein have the same meanings as those commonly understood by a person skilled in the technical field of embodiments described herein. In the event of any inconsistency, the meaning described herein or the meaning derived from the content disclosed herein shall prevail. In addition, terms used herein are merely for the purpose of describing embodiments described herein, but are not intended to limit embodiments described herein.

To accurately describe technical content in embodiments described herein and accurately understand embodiments described herein, before specific implementations are described, the following explanations or definitions are provided for terms and related technologies used herein.

### (1) Full Polarization Radar, Polarization Scattering Matrix, and Pulse Repetition Interval

The full polarization radar: Polarization, amplitude, frequency, and phase form complete description of an electromagnetic wave, which is one of essential features of a target. A polarization characteristic of the target is described by using a target polarization scattering matrix (polarization scattering matrix, PSM). The polarization scattering matrix provides richer electromagnetic scattering information than a radar cross section (radar-cross section, RCS), and improves radar performance in terms of anti-interference, anti-stealth, anti-clutter, and the like. Accurate target PSM measurement is a premise and basis of using target polarization information. Currently, a radar used for the target PSM measurement is referred to as the full polarization radar.

The polarization scattering matrix (polarization scattering matrix, PSM) is used to describe the polarization characteristic of the target, and provides richer electromagnetic scattering information than the radar cross section (radar-cross section, RCS). Radar ranging and the like is implemented based on PSM information. A parameter in the PSM is a target scattering coefficient.

The pulse repetition interval (Pulse Repetition Interval, PRI) is a time interval between one pulse and a next pulse.

### (2) Simulated Annealing Algorithm and Coordinate Descent Algorithm

The simulated annealing (Simulated Annealing, SA) algorithm comes from a solid annealing principle. A solid is warmed to a specific high level and then cooled slowly. In response to the solid being warmed, particles inside the solid become disordered with a temperature rise, and internal energy increases. In response to the solid being cooled slowly, the particles gradually become orderly, reach an equilibrium state at each temperature, and finally reach a ground state at a room temperature. The internal energy is reduced to minimum. According to the Metropolis criterion, a probability that the particles tend to be balanced at a temperature T is e(−ΔE/(kT)), where E is internal energy at the temperature T, ΔE is a change amount of E, and k is a Boltzmann constant. Solid annealing is used to simulate a combination optimization problem. The internal energy E is simulated as a target function value f, and the temperature T evolves into a control parameter t. In other words, the simulated annealing algorithm for solving the combination optimization problem is obtained. Starting from an initial solution i and an initial value t of the control parameter, an iteration of “S1: generate a new solution; S2: calculate a target function difference; and S3: accept or discard” is repeated for a current solution, and the value t is gradually attenuated. A current solution at the end of the algorithm is an approximate optimal solution. This is a heuristic random search process based on a Monte Carlo iterative solving method. Control of the annealing process includes the initial value t of the control parameter, an attenuation factor Δt of the control parameter, a quantity of iterations L for each t value, and a stop condition S.

The coordinate descent (Coordinate Descent, CD) algorithm is a non-gradient optimization algorithm. In each iteration, the algorithm performs a one-dimensional search at a current point in a coordinate direction to obtain a local minimum value of a function. Different coordinate directions are cyclically used throughout the process.

In addition, a unit modulus sequence in at least one embodiment is a sequence in which modulus lengths of elements of the sequence are all 1. A binary sequence is a sequence in which a size of a letter set of element values is 2, and is usually {−1, 1} or {0, 1}. The letter set is a set of values of an element. Further, because the polarization scattering matrix (PSM) is a prerequisite for implementing ranging, the following describes a process of obtaining the PSM information based on a sequence used for sensing.

The full polarization radar system is a system that simultaneously sends and receives signals on two orthogonal polarizations. The system sends and receives the sequence used for sensing, and further calculates a self-ambiguity function and a mutual ambiguity function of a received sequence. Therefore, the PSM information is further obtained, and ranging information is obtained based on the PSM information.

A model definition of the full polarization radar system is shown in Table 1.

TABLE 1

| | | | | | | | |
|---|---|---|---|---|---|---|---|
| Transmit | s_{V,0} | s_{V,1} | s_{V,2} | . . . | s_{V,n} | . . . | s_{V,N-1} |
| antenna in a | | | | | | | |
| vertical | | | | | | | |
| polarization | | | | | | | |
| direction V | | | | | | | |
| (V transmitter) | | | | | | | |
| Transmit | s_{H,0} | s_{H,1} | s_{H,2} | . . . | s_{H,n} | . . . | s_{H,N-1} |
| antenna in a | | | | | | | |
| horizontal | | | | | | | |
| polarization | | | | | | | |
| direction H | | | | | | | |
| (H transmitter) | | | | | | | |
| Receive | r_{V,0} | r_{V,1} | r_{V,2} | . . . | r_{V,n} | . . . | r_{V,N-1} |
| antenna in | | | | | | | |
| the vertical | | | | | | | |
| polarization | | | | | | | |
| direction V | | | | | | | |
| (V receiver) | | | | | | | |
| Receive | r_{H,0} | r_{H,1} | r_{H,2} | . . . | r_{H,n} | . . . | r_{H,N-1} |
| antenna in the | | | | | | | |
| horizontal | | | | | | | |
| polarization | | | | | | | |
| direction H | | | | | | | |
| (H receiver) | | | | | | | |
| Filter bank | [\tilde{s}_{V,0} \| \tilde{s}_{H,0}] | [\tilde{s}_{V,1} \| \tilde{s}_{H,1}] | [\tilde{s}_{V,2} \| \tilde{s}_{H,2}] | . . . | [\tilde{s}_{V,n} \| \tilde{s}_{H,n}] | . . . | [\tilde{s}_{V,N-1} \| \tilde{s}_{H,N-1}] |
| disposed at | | | | | | | |
| the receive | | | | | | | |
| antenna in | | | | | | | |
| the vertical | | | | | | | |
| polarization | | | | | | | |
| direction V | | | | | | | |
| (V Filter) | | | | | | | |
| Filter bank | [\tilde{s}_{V,0} \| \tilde{s}_{H,0}] | [\tilde{s}_{V,1} \| \tilde{s}_{H,1}] | [\tilde{s}_{V,2} \| \tilde{s}_{H,2}] | . . . | [\tilde{s}_{V,n} \| \tilde{s}_{H,n}] | . . . | [\tilde{s}_{V,N-1} \| \tilde{s}_{H,N-1}] |
| disposed at | | | | | | | |
| the receive | | | | | | | |
| antenna in the | | | | | | | |
| horizontal | | | | | | | |
| polarization | | | | | | | |
| direction H | | | | | | | |
| (H Filter) | | | | | | | |

Output=

[symbol]

In Table 1, a first row in a model of the full polarization radar system indicates that N sequences are sent over the transmit antenna in the vertical polarization direction V, where s_{V,n} indicates a sequence sent in an n^{th} pulse repetition interval PRI. A second row indicates that N sequences are sent over the transmit antenna in the horizontal polarization direction H, where S_{H,n} indicates a sequence sent in the n^{th} pulse repetition interval PRI. A third row and a fourth row indicate that N sequences are received over two receive antennas V and H in vertical and horizontal polarization directions, where r_{V,n} and r_{H,n} separately indicate sequences that are corresponding to the antennas and that are received in the n^{th} pulse repetition interval PRI. A fifth row indicates the filter bank disposed at the receive antenna in the vertical polarization direction V, and the filter bank matches s_{V,0} and s_{H,0}. A sixth row indicates the filter bank disposed at the receive antenna in the horizontal polarization direction H, and the filter bank matches s_{V,0} and s_{H,0}. ˜ in the fifth and sixth rows indicates an inverted conjugate.

In addition, the foregoing output indicates that a sum of outputs corresponding to each of the N PRIs forms a total output. [symbol] is a matrix, and indicates an output corresponding to the n^{th} PRI.

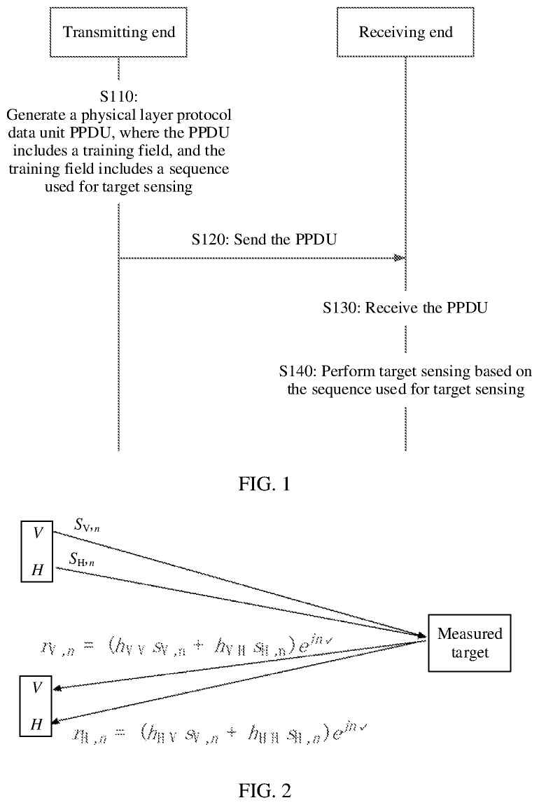

FIG. 2 is a transmission and reception diagram of a radar system. A radar transmit signal corresponding to the n^{th} PRI is sₙ, and a vector rₙ of a signal received by the radar is:

$${r}_{n} = H {s}_{n} {e}^{j n θ} .$$

$$H = [ \begin{matrix}{h}_{VV} & {h}_{VH} \\ {h}_{HV} & {h}_{HH}\end{matrix} ] , {s}_{n} = [ \begin{matrix}{s}_{V , n} \\ {s}_{H , n}\end{matrix} ] , and {r}_{n} = [ \begin{matrix}{r}_{V , n} \\ {r}_{H , n}\end{matrix} ] .$$

An H matrix corresponds to the PSM. h_{VH} indicates a target scattering coefficient for entering the vertical polarization direction V from the horizontal polarization direction H, h_{HV} indicates a target scattering coefficient for entering the horizontal polarization direction H from the vertical polarization direction V, h_{VV} indicates a target scattering coefficient for entering the vertical polarization direction V from the vertical polarization direction V, h_{HH} indicates a target scattering coefficient for entering the horizontal polarization direction H from the horizontal polarization direction H, and θ indicates a Doppler shift.

After the vector rₙ of the received signal passes through the filter bank in the n^{th} PRI, the output [symbol] of the n^{th} PRI is:

$$\begin{matrix}O {n}_{n} ( k ) & = [ \begin{matrix}( {r}_{V , n} * {\tilde{s}}_{V , n} ) ( k ) & ( {r}_{V , n} * {\tilde{s}}_{H , n} ) ( k ) \\ ( {r}_{H , n} * {\tilde{s}}_{V , n} ) ( k ) & ( {r}_{H , n} * {\tilde{s}}_{H , n} ) ( k )\end{matrix} ] \\ & = {e}^{j n θ} [ \begin{matrix}{h}_{VV} {c}_{V , n} ( k ) + {h}_{VH} {c}_{HV , n} ( k ) & {h}_{VV} {c}_{VH , n} ( k ) + {h}_{VH} {c}_{H , n} ( k ) \\ {h}_{HV} {c}_{V , n} ( k ) + {h}_{HH} {c}_{HV , n} ( k ) & {h}_{HV} {c}_{VH , n} ( k ) + {h}_{HH} {c}_{H , n} ( k )\end{matrix} ] \\ & = {e}^{j n θ} [ \begin{matrix}{h}_{VV} & {h}_{VH} \\ {h}_{HV} & {h}_{HH}\end{matrix} ] [ \begin{matrix}{c}_{V , n} ( k ) & {c}_{VH , n} ( k ) \\ {c}_{HV , n} ( k ) & {c}_{H , n} ( k )\end{matrix} ]\end{matrix} .$$

r_{V,n}*\tilde{s}_{V,n} indicates that r_{V,n} and \tilde{s}_{V,n} are convolved; r_{H,n}*\tilde{s}_{V,n} indicates that r_{H,n} and \tilde{s}_{V,n} are convolved; r_{V,n}*\tilde{s}_{H,n} indicates that r_{V,n} and \tilde{s}_{H,n} are convolved; r_{H,n}*\tilde{s}_{H,n} indicates that r_{H,n} and \tilde{s}_{H,n} are convolved; \tilde{s}_{V,n} indicates an inverted conjugate of s_{V,n}; \tilde{s}_{H,n} indicates an inverted conjugate of s_{H,n}; k indicates a delay; and [symbol] indicates the output of the n^{th} PRI after the vector rₙ of the received signal passes through the filter bank in the n^{th} PRI.

$${c}_{V , n} ( k ) = ( {s}_{V , n} * {\tilde{s}}_{V , n} ) ( k ) = \{ \begin{matrix}{\sum }_{l = 0}^{L - k - 1} {s}_{V , n} ( l ) {\tilde{s}}_{V , n} ( l + k ) & if k \geq 0 \\ {\sum }_{l = 0}^{L + k - 1} {s}_{V , n} ( l - k ) {\tilde{s}}_{V , n} ( l ) & if k < 0\end{matrix} ; and$$

$${c}_{VH , n} ( k ) = ( {s}_{V , n} * {\tilde{s}}_{H , n} ) ( k ) = \{ \begin{matrix}{\sum }_{l = 0}^{L - k - 1} {s}_{V , n} ( l ) {\tilde{s}}_{HV , n} ( l + k ) & if k \geq 0 \\ {\sum }_{l = 0}^{L + k - 1} {s}_{V , n} ( l - k ) {\tilde{s}}_{H , n} ( l ) & if k < 0\end{matrix} .$$

s_{V,n}*\tilde{s}_{V,n} indicates that s_{V,n} and \tilde{s}_{V,n} are convolved; s_{V,n}*\tilde{s}_{H,n} indicates that s_{V,n} and \tilde{s}_{V,n} are convolved; L indicates a sequence length; l indicates an l^{th} element of a current sequence; and k indicates a delay.

Therefore, outputs of all PRIs, that is, a total output of the system, is as follows:

$$\begin{matrix}Output ( k ) & = {\sum }_{n = 0}^{N - 1} O {n}_{n} ( k ) = {\sum }_{n = 0}^{N - 1} {e}^{j n θ} [ \begin{matrix}{h}_{VV} {c}_{V , n} ( k ) + {h}_{VH} {c}_{HV , n} ( k ) & {h}_{VV} {c}_{VH , n} ( k ) + {h}_{VH} {c}_{H , n} ( k ) \\ {h}_{HV} {c}_{V , n} ( k ) + {h}_{HH} {c}_{HV , n} ( k ) & {h}_{HV} {c}_{VH , n} ( k ) + {h}_{HH} {c}_{H , n} ( k )\end{matrix} ] . \\ & = [ \begin{matrix}{h}_{VV} & {h}_{VH} \\ {h}_{HV} & {h}_{HH}\end{matrix} ] [ \begin{matrix}{\sum }_{n = 0}^{N ‐ 1} {c}_{V , n} ( k ) {e}^{j n θ} & {\sum }_{n = 0}^{N ‐ 1} {c}_{VH , n} ( k ) {e}^{j n θ} \\ {\sum }_{n = 0}^{N ‐ 1} {c}_{HV , n} ( k ) {e}^{j n θ} & {\sum }_{n = 0}^{N ‐ 1} {c}_{H , n} ( k ) {e}^{j n θ}\end{matrix} ]\end{matrix}$$

Corresponding to the foregoing formula, an ambiguity function of a matrix value is:

$$[ \begin{matrix}{g}_{V , V} ( k , θ ) & {g}_{V , H} ( k , θ ) \\ {g}_{H , V} ( k , θ ) & {g}_{H , H} ( k , θ )\end{matrix} ] = [ \begin{matrix}{\sum }_{n = 0}^{N - 1} {c}_{V , n} ( k ) {e}^{j n θ} & {\sum }_{n = 0}^{N - 1} {c}_{VH , n} ( k ) {e}^{j n θ} \\ {\sum }_{n = 0}^{N - 1} {c}_{HV , n} ( k ) {e}^{j n θ} & {\sum }_{n = 0}^{N - 1} {c}_{H , n} ( k ) {e}^{j n θ}\end{matrix} ] .$$

Two ambiguity functions g_{V,V}(k, θ) and g_{H,H}(k, θ) on a primary diagonal are a self-ambiguity function of the sequence received in the vertical polarization direction V and a self-ambiguity function of the sequence received in the horizontal polarization direction H respectively. Two ambiguity functions g_{H,V}(k, θ) and g_{H,H}(k, θ) on a secondary diagonal are a mutual ambiguity function of the sequence received in the vertical polarization direction V and a mutual ambiguity function of the sequence received in the horizontal polarization direction H respectively. The self-ambiguity function and the mutual ambiguity function is obtained through calculation according to respective ambiguity function formulas, that is,

$$[ \begin{matrix}{g}_{V , V} ( k , θ ) & {g}_{V , H} ( k , θ ) \\ {g}_{H , V} ( k , θ ) & {g}_{H , H} ( k , θ )\end{matrix} ]$$

is obtained.

$$Because [ \begin{matrix}{g}_{V , V} ( k , θ ) & {g}_{V , H} ( k , θ ) \\ {g}_{H , V} ( k , θ ) & {g}_{H , H} ( k , θ )\end{matrix} ] = [ \begin{matrix}{\sum }_{n = 0}^{N - 1} {c}_{V , n} ( k ) {e}^{j n θ} & {\sum }_{n = 0}^{N - 1} {c}_{VH , n} ( k ) {e}^{j n θ} \\ {\sum }_{n = 0}^{N - 1} {c}_{HV , n} ( k ) {e}^{j n θ} & {\sum }_{n = 0}^{N - 1} {c}_{H , n} ( k ) {e}^{j n θ}\end{matrix} ] , [ \begin{matrix}{\sum }_{n = 0}^{N - 1} {c}_{V , n} ( k ) {e}^{j n θ} & {\sum }_{n = 0}^{N - 1} {c}_{VH , n} ( k ) {e}^{j n θ} \\ {\sum }_{n = 0}^{N - 1} {c}_{HV , n} ( k ) {e}^{j n θ} & {\sum }_{n = 0}^{N - 1} {c}_{H , n} ( k ) {e}^{j n θ}\end{matrix} ] is obtained .$$

On this basis, because the total output (k) of the system is known,

$$[ \begin{matrix}{h}_{VV} & {h}_{VH} \\ {h}_{HV} & {h}_{HH}\end{matrix} ] ,$$

that is, the foregoing

$$H = [ \begin{matrix}{h}_{VV} & {h}_{VH} \\ {h}_{HV} & {h}_{HH}\end{matrix} ] ,$$

which is the target polarization scattering matrix (PSM), is further obtained according to the foregoing output (k) formula. Further, the ranging information is obtained by using the PSM. The foregoing describes how to send and receive the sequence by using the full polarization radar system, further calculate the self-ambiguity function and the mutual ambiguity function of the sequence, and further obtain the PSM to obtain the ranging information. From the foregoing, to implement ranging sensing, the sequence used for sensing is to be sent and received. Therefore, quality of the sequence is important for sensing performance. However, an existing sequence is designed for optimal communication, and therefore optimal sensing cannot be implemented.

Therefore, in embodiments described herein, the sequence used for sensing is optimized and designed, so that the sequence is applied to an existing high frequency band related standard, and is used for target sensing with high performance The following describes in detail a data transmission method provided in at least one embodiment with reference to the accompanying drawings. Specifically, as shown in FIG. 1, the method includes the following steps.
S110: A transmitting end generates a physical layer protocol data unit PPDU, where the PPDU includes a training field, and the training field includes a sequence used for target sensing.

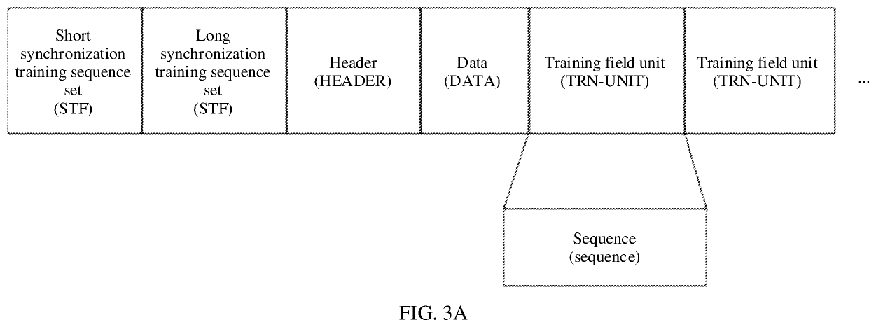

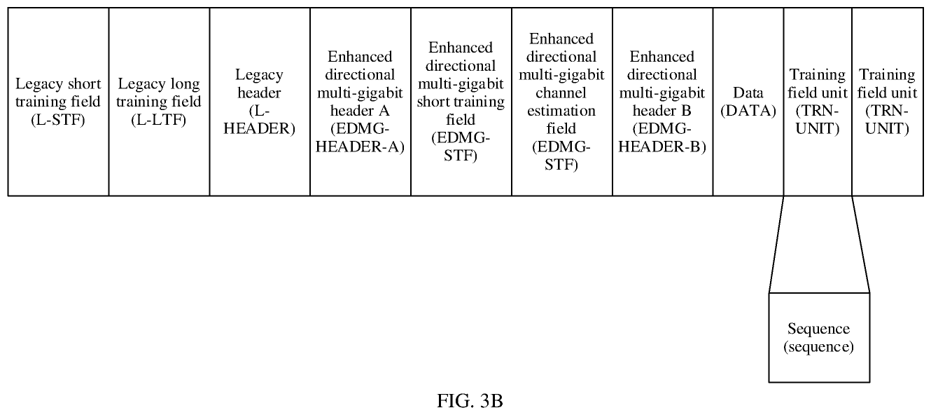

In at least one embodiment, FIG. 3A shows a frame structure of a high frequency band 802.11ad. A training field unit (TRN-UNIT) shown in FIG. 3A includes the foregoing sequence used for target sensing. In the 802.11ad standard, target sensing is performed by using the sequence. In this way, sensing performance is improved. For another example, FIG. 3B shows a frame structure of a high frequency band 802.11ay. A training field unit (TRN-UNIT) shown in FIG. 3B includes the foregoing sequence used for sensing. Similarly, in the 802.11ay standard, target sensing is performed by using the sequence. In this way, sensing performance is also improved.
S120: The transmitting end sends the PPDU.

Optionally, the transmitting end sends the PPDU in a broadcast, unicast, or multicast manner.
S130: A receiving end receives the PPDU.

The receiving end receives the PPDU, and performs target sensing by using the sequence included in the PPDU.

Specifically, in step S110, the sequence that is used for target sensing and that is included in the training field is obtained based on a binary sequence pair, an Alamouti matrix, and a Prouhet-Thue-Morse PTM (Prouhet-Thue-Morse, PTM) sequence, where the Alamouti matrix includes:

$$A 0 = [ \begin{matrix}x , & - \tilde{y} \\ y , & \tilde{x}\end{matrix} ] and A 1 = [ \begin{matrix}- \tilde{y} , & - x \\ \tilde{x} , & - y\end{matrix} ] .$$

In response to x and y being the binary sequence pair, \tilde{x} and \tilde{y} are respectively inverted complex conjugates of x and y, the matrix A0 corresponds to 0 in the PTM sequence, and the matrix A1 corresponds to 1 in the PTM sequence. To be specific, in response to an element value in the PTM sequence being 0, the value in the PTM sequence corresponds to A0 in the Alamouti matrix; and in response to an element value in the PTM sequence being 1, the element value in the PTM sequence corresponds to A1 in the Alamouti matrix.

The first matrix is obtained according to the foregoing correspondence between a PTM sequence and an Alamouti matrix. A first row of the first matrix forms a sequence in a V polarization direction, and a second row of the matrix forms a sequence in an H polarization direction. In other words, the first row and the second row of the first matrix form the sequence used for target sensing in at least one embodiment. Further, the PTM sequence is {aₙ}ₙ₌₀^{N-1}, and its recursion is defined as a₀=0, a₂ₖ=aₖ, and a₂ₖ₊₁=1−aₖ, where k>0, a length of the PTM sequence is 2^{M+1} and M is an integer greater than 0. M has different values. Specifically, different values of M correspond to sequences of different lengths used for sensing. A larger value of M indicates a longer correspondingly generated sequence used for target sensing, less interference between sequences in response to the sequence being used for sensing, and better sensing performance.

For example, the following provides several different M values to correspondingly obtain sequences of different lengths used for sensing. A value of M is merely an example, and is not limited to the following several values. Based on the foregoing description, M is any integer value greater than 0. In addition, in the following embodiment, x and y are the binary sequence pair, \tilde{x} and \tilde{y} and are respectively the inverted complex conjugates of x and y. For brevity, unified description is provided herein. Details are not described below again.

In an embodiment, in response to M=1, sequences used for target sensing are S_{Vm11} and S_{Hm12}. Specifically, the sequences used for target sensing are:

S_{Vm11}=[x,−\tilde{y},−\tilde{y},−x,−\tilde{y},−x,x,−\tilde{y}]; and

S_{Hm12}=[y,\tilde{x},\tilde{x},−y,\tilde{x},−y,y,\tilde{x}].

Specifically, in response to M=1, a length of the PTM sequence is 4, a value of the PTM sequence is 0110, and the first matrix A=[A0 A1 A1 A0] obtained according to the correspondence between an Alamouti matrix and a PTM sequence is specifically:

$$A = [ \begin{matrix}x , & - \tilde{y} , & - \tilde{y} , & - x , & - \tilde{y} , & - x , & x , & - \tilde{y} \\ y , & \tilde{x} , & \tilde{x} , & - y , & \tilde{x} , & - y , & y , & \tilde{x}\end{matrix} ] .$$

A first row of the first matrix corresponds to S_{Vm11} of the target sensing sequences, and a second row of the first matrix corresponds to S_{Hm12} of the target sensing sequences.

In still another embodiment, in response to M=2, sequences used for target sensing are S_{Vm21} and S_{Hm22}, where S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and S_{Hm22}=[y,\tilde{x},\tilde{x},−y,\tilde{x},−y,y,\tilde{x},\tilde{x},−y,y,\tilde{x},y,\tilde{x},\tilde{x},−y].

Specifically, in response to M=2, a length of the PTM sequence is 16, a value of the PTM sequence is 01101001, and the PTM sequence 01101001 corresponds to eight Alamouti matrices A0 A1 A1 A0 A1 A0 A0 A1. The eight Alamouti matrices form a first matrix A2=[A0 A1 A1 A0 A1 A0 A0 A1]. Specifically,

$$A 2 = [ \begin{matrix}x , & - \tilde{y} , & - \tilde{y} , & - x , & - \tilde{y} , & - x , & x , & - \tilde{y} , & - \tilde{y} , & - x , & x , & - \tilde{y} , & x , & - \tilde{y} , & - \tilde{y} , & - x \\ y , & \tilde{x} , & \tilde{x} , & - y , & \tilde{x} , & - y , & y , & \tilde{x} , & \tilde{x} , & - y , & y , & \tilde{x} , & y , & \tilde{x} , & \tilde{x} , & - y\end{matrix} ] .$$

A first row of the first matrix A2 corresponds to S_{Vm11}, and a second row of the first matrix A2 corresponds to S_{Hm12}.

In still another embodiment, in response to M=3, sequences used for target sensing are S_{Vm31} and S_{Hm32}, where

S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and

S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

Specifically, in response to M=3, a length of the PTM sequence is 16, a value of the PTM sequence is 0110100110010110, and the PTM sequence 0110100110010110 corresponds to 16 Alamouti matrices A0 A1 A1 A0 A1 A0 A0 A1 A1 A0 A0 A1 A0 A1 A1 A0. The 16 Alamouti matrices form a first matrix A3=[A0 A1 A1 A0 A1 A0 A0 A1 A1 A0 A0 A1 A0 A1 A1 A0]. Specifically,

$$A 3 = [ \begin{matrix}x , & - \tilde{y} , & - \tilde{y} , & - x , & - \tilde{y} , & - x , & x , & - \tilde{y} , & - \tilde{y} , & - x , & x , & - \tilde{y} , & x , & - \tilde{y} , & - \tilde{y} , & - x , \\ y , & \tilde{x} , & \tilde{x} , & - y , & \tilde{x} , & - y , & y , & \tilde{x} , & \tilde{x} , & - y , & y , & \tilde{x} , & y , & \tilde{x} , & \tilde{x} , & - y ,\end{matrix} \begin{matrix}- x , & x , & - \tilde{y} , & x , & - \tilde{y} , & - \tilde{y} , \\ - y , & y , & \tilde{x} , & y , & \tilde{x} , & \tilde{x} ,\end{matrix} \\ \begin{matrix}- x , & x , & - \tilde{y} , & - \tilde{y} , & - x , & - \tilde{y} , & - x , & x , & - \tilde{y} \\ - y , & y , & \tilde{x} , & \tilde{x} , & - y , & \tilde{x} , & - y , & y , & \tilde{x}\end{matrix} ] .$$

A first row of the first matrix A3 corresponds to S_{Vm11} of the target sensing sequences, and a second row of the first matrix A3 corresponds to S_{Hm12} of the target sensing sequences.

Based on the foregoing embodiment, sequences of different lengths used for target sensing is obtained based on the binary sequence pair, the Alamouti matrix, and the PTM sequence, and are applicable to different target sensing scenarios. In addition, the sequence used for sensing has high Doppler tolerance.

Further, a sequence length of the binary sequence pair used to generate the sequence used for sensing includes any one of the following: 256 bits, 512 bits, 1024 bits, and 2048 bits.

In an embodiment, the sequence length of the binary sequence pair is the 256 bits, and sequences corresponding to the binary sequence pair are:
Sn2561=[−1 −1 −1 −1 −1 −1 1 −1 1 −1 −1 −1 1 −1 1 1 1 1 1 1 1 1 −1 1 −1 1 −1 −1 1 −1 1 −1 −1 −1 1 1 1 1 −1 1 −1 1 −1 −1 −1 −1 1 −1 1 −1 −1 −1 1 1 −1 −1 −1 −1 1 1 −1 1 −1 1 −1 1 −1 −1 −1 1 −1 1 1 1 −1 1 −1 −1 −1 −1 1 1 −1 1 1 1 −1 1 1 1 −1 −1 1 1 1 −1 −1 1 1 −1 1 1 −1 −1 1 −1 1 1 −1 −1 1 1 −1 −1 −1 −1 1 1 −1 −1 1 1 −1 1 1 −1 −1 1 −1 −1 −1 1 1 −1 −1 1 −1 −1 −1 −1 −1 −1 1 1 −1 −1 1 −1 −1 1 −1 −1 1 −1 1 −1 1 −1 −1 1 1 −1 −1 −1 −1 −1 1 −1 1 −1 1 −1 −1 −1 1 −1 −1 −1 1 1 −1 1 −1 1 −1 1 1 −1 −1 −1 1 −1 −1 1 1 1 1 −1 1 1 −1 1 −1 1 1 −1 1 −1 1 −1 −1 1 1 1 −1 −1 −1 −1 1 −1 −1 1 −1 1 1 −1 1 1 −1 1 1 1 1 1 1 1 1 1 1 −1 −1 −1 −1 −1 1 1 −1 1 1 1 1 1 1 1 −1 1]; and
Sn2562=[1 −1 1 1 −1 1 1 1 1 −1 −1 −1 −1 1 1 −1 1 −1 1 1 −1 1 −1 −1 1 −1 −1 −1 −1 −1 −1 −1 1 1 −1 −1 −1 −1 −1 −1 1 1 −1 1 1 1 1 1 1 −1 1 −1 1 1 −1 −1 1 −1 1 1 −1 −1 1 1 −1 1 −1 1 −1 −1 −1 1 −1 1 1 −1 −1 1 1 −1 1 −1 1 1 1 −1 1 −1 −1 1 −1 −1 1 1 1 −1 −1 1 1 1 1 1 −1 −1 1 −1 1 1 1 −1 −1 −1 1 1 1 −1 −1 −1 1 −1 −1 −1 −1 1 1 −1 −1 1 1 −1 1 −1 1 1 1 1 −1 −1 1 −1 1 1 1 1 1 −1 −1 −1 −1 1 −1 −1 −1 −1 1 1 1 1 −1 −1 −1 1 1 1 1 1 −1 −1 −1 −1 1 1 1 1 1 1 −1 1 −1 −1 1 1 1 −1 1 −1 1 −1 1 1 −1 −1 −1 1 1 −1 1 1 1 −1 1 1 1 1 −1 1 −1 −1 −1 −1 1 −1 1 −1 −1 −1 1 1 1 −1 −1 −1 1 −1 −1 −1 1 1 1 −1 1 1 −1 −1 1 1 −1 1 −1 1 1 1 −1 1 −1 1 1 1 1 1 1 −1 −1 1 1 −1].

That is, in the binary sequence pair, x corresponds to Sn2561, and y corresponds to Sn2562.

In an embodiment, the sequence length of the binary sequence pair is the 512 bits, and sequences corresponding to the binary sequence pair are:
Sn5121=[1 1 1 −1 1 −1 1 −1 −1 1 −1 −1 −1 −1 −1 −1 1 1 1 −1 1 1 −1 1 1 −1 1 −1 1 1 −1 −1 1 1 1 1 −1 −1 1 −1 −1 −1 1 1 1 1 −1 1 −1 −1 1 1 −1 1 −1 −1 1 1 1 1 −1 1 −1 1 1 1 1 −1 1 −1 −1 −1 −1 1 −1 1 1 1 −1 1 −1 −1 −1 1 1 −1 1 1 −1 1 −1 −1 −1 −1 −−1 1 1 1 −1 −1 −1 1 1 1 1 1 1 1 1 −1 −1 1 −1 1 1 1 −1 1 1 1 −1 −1 1 1 −1 1 1 −1 −1 1 −1 1 1 1 −1 1 1 −1 −1 1 1 1 −1 1 1 −1 1 −1 −1 −1 −1 −1 1 1 1 −1 −1 1 −1 −1 1 −1 1 1 −1 −1 −1 1 −1 −1 −1 1 −1 1 1 1 1 1 1 1 1 −1 1 −1 −1 −1 −1 1 1 1 1 1 1 −1 −1 −1 1 1 1 1 1 1 1 1 1 −1 −1 1 −1 −1 1 −1 1 −1 −1 −1 −1 −1 1 1 −1 −1 −1 1 1 1 −1 −1 1 1 1 1 1 1 1 1 1 −1 −1 1 1 −1 −1 −1 1 1 −1 −1 1 −1 1 1 −1 −1 −1 −1 −1 −1 −1 −1 1 −1 1 −1 1 1 −1 1 −1 1 1 −1 −1 1 −1 1 −1 −1 −1 −1 −1 −1 −1 1 1 1 −1 1 1 −1 −1 1 −1 1 1 −1 −1 −1 −1 −1 −1 −1 1 −1 1 −1 1 −1 1 1 −1 −1 1 1 −1 −1 −1 −1 −1 −1 −1 1 1 −1 −1 −1 1 1 −1 −1 −1 1 1 1 −1 1 1 1 −1 1 1 1 −1 −1 1 1 1 1 −1 −1 −1 1 −1 1 −1 −1 −1 1 −1 −1 1 −1 1 −1 1 −1 1 −1 1 −1 −1 −1 −1 1 1 −1 −1 −1 −1 −1 −1 1 −1 −1 −1 −1 −1 1 −1 1 1 −1 1 −1 1 1 1 1 1 −1 −1 1 1 −1 1 −1 −1 1 −1 −1 1 −1 1 1 −1 1 −1 −1 −1 −1 1 1 −1 1 1 −1 1 −1 −1 1 1 −1 −1 −1 1 1 1 −1 1 −1 −1 1 −1 −1 −1 1 1 −1 −1 −1 −1 1 1 −1 1 −1 −1 −1 −1 1 1 1 −1 −1 1 −1 1 1 1 1 1 −1 1 1 −1 −1 1 1 −1 1 1 1 1 −1 −1 −1 1 1 1 −1 −1 −1 1 1 1 1 −1 1 −1 1 1 −1 −1 −1 1 1 1 −1 1 −1 −1]; and
Sn5122=[−1 −1 1 1 −1 −1 −1 1 1 1 1 1 −1 −1 1 −1 1 −1 −1 −1 1 −1 −1 −1 1 1 1 1 1 1 1 1 1 −1 1 1 1 1 1 −1 1 1 1 1 −1 1 −1 1 −1 −1 −1 1 −1 −1 1 1 −1 −1 −1 −1 −1 1 1 1 1 −1 1 1 −1 −1 −1 −1 1 −1 1 −1 1 1 1 1 1 1 −1 1 1 −1 1 1 −1 1 −1 1 −1 1 −1 −1 1 1 −1 −1 −1 −1 −1 −1 1 −1 −1 1 −1 1 1 −1 1 −1 −1 1 −1 1 −1 −1 −1 1 −1 −1 −1 1 −1 1 −1 1 −1 1 −1 −1 1 −1 −1 −1 −1 1 −1 −1 −1 1 1 −1 1 1 1 −1 1 1 −1 −1 −1 1 −1 1 1 −1 −1 −1 1 1 1 −1 1 −1 −1 −1 1 1 −1 1 −1 1 −1 1 −1 1 1 1 −1 1 1 1 −1 1 1 1 1 −1 −1 −1 −1 1 1 1 −1 1 −1 −1 −1 1 1 1 −1 −1 −1 −1 −1 −1 1 1 −1 −1 −1 −1 1 −1 −1 −1 −1 −1 −1 1 1 1 −1 1 1 −1 1 −1 −1 −1 −1 1 −1 1 1 −1 −1 −1 1 −1 −1 −1 1 1 1 −1 −1 −1 1 −1 1 1 −1 −1 1 −1 −1 1 1 −1 1 1 1 1 −1 1 1 −1 −1 1 1 −1 1 1 −1 −1 1 1 −1 1 1 −1 1 −1 1 −1 −1 −1 1 1 −1 −1 −1 1 −1 −1 1 1 −1 −1 1 1 1 −1 1 −1 −1 1 −1 1 −1 −1 1 1 −1 1 −1 1 −1 1 −1 −1 1 −1 1 1 1 −1 1 −1 1 1 1 1 1 −1 1 −1 1 −1 −1 −1 −1 1 1 1 −1 1 1 −1 −1 −1 1 −1 1 1 1 1 1 −1 1 1 1 −1 1 −1 −1 −1 −1 1 −1 1 −1 −1 1 −1 1 1 1 −1 1 1 −1 −1 −1 −1 −1 1 1 −1 −1 1 −1 −1 −1 −1 −1 1 1 −1 −1 1 −1 −1 1 −1 1 1 1 −1 −1 1 −1 −1 −1 −1 −1 −1 −1 1 1 −1 1 1 1 1 −1 −1 −1 −1 −1 −1 −1 −1 −1 −1 1 1 −1 −1 1 −1 1 1 −1 1 −1 −1 1 1 −1 1 1 −1 −1 −1 1 −1 1 1 −1 1 −1 1 −1 −1 1 −1 −1 1 −1 1 1 1 1 −1 −1 1 1 −1 −1 1 −1 1 −1 1 1 1 1 1 −1 −1 −1 1 1 −1 1 1 1 −1 1 1 −1 1 −1 −1].

That is, in the binary sequence pair, x corresponds to Sn5121, and y corresponds to Sn5122.

In an embodiment, the sequence length of the binary sequence pair is 1024, and sequences corresponding to the binary sequence pair are:
Sn10241=[1 −1 −1 −1 −1 −1 −1 1 −1 −1 −1 1 −1 1 −1 1 1 1 −1 −1 −1 −1 −1 1 −1 1 1 1 1 −1 −1 1 −1 1 1 −1 −1 −1 1 1 1 1 −1 −1 −1 1 −1 1 −1 1 −1 1 1 1 1 −1 −1 1 1 1 1 1 1 1 1 1 1 1 −1 1 −1 1 −1 −1 1 1 −1 1 −1 −1 −1 1 −1 1 1 −1 1 −1 −1 −1 −1 1 1 1 1 −1 −1 1 −1 1 −1 1 −1 −1 1 1 −1 −1 1 −1 −1 −1 1 −1 1 −1 1 1 1 −1 −1 −1 1 1 1 1 1 1 −1 −1 1 1 −1 1 1 −1 1 −1 −1 −1 −1 −1 −1 1 −1 1 −1 −1 1 1 −1 1 −1 −1 −1 −1 −1 −1 −1 −1 −1 1 1 −1 −1 1 1 −1 −1 1 1 1 −1 1 1 −1 −1 1 −1 −1 1 1 −1 −1 −1 −1 1 1 1 1 1 1 1 −1 −1 1 1 1 1 −1 −1 −1 −1 −1 −1 1 −1 1 −1 1 1 1 −1 1 1 1 −1 −1 1 1 −1 −1 −1 1 1 1 −1 1 −1 −1 −1 −1 1 −1 −1 1 −1 −1 1 1 −1 1 1 −1 −1 −1 −1 1 1 1 −1 1 1 −1 −1 −1 1 1 1 1 1 1 −1 1 1 −1 −1 −1 1 1 1 −1 1 1 1 −1 −1 1 1 1 1 −1 1 1 −1 1 1 −1 1 −1 1 −1 1 1 1 1 1 −1 1 1 1 1 −1 1 1 1 −1 1 1 1 −1 1 1 1 1 1 1 −1 −1 −1 1 1 −1 −1 1 1 −1 1 1 −1 1 −1 1 −1 1 −1 −1 1 1 −1 −1 1 1 1 1 1 −1 −1 1 −1 1 1 1 −1 1 −1 −1 −1 1 −1 1 −1 −1 1 −1 −1 −1 −1 1 1 1 1 1 −1 1 1 −1 1 −1 −1 −1 1 −1 1 −1 1 1 1 −1 −1 1 −1 1 −1 1 −1 1 1 1 1 1 1 −1 −1 −1 −1 −1 −1 1 −1 −1 −1 1 −1 −1 1 1 1 1 −1 −1 −1 −1 −1 1 1 1 1 1 −1 −1 1 1 −1 1 −1 1 −1 1 1 −1 1 −1 −1 1 1 −1 1 −1 1 1 1 1 1 −1 1 −1 1 −1 −1 1 −1 −1 1 1 −1 1 1 −1 1 −1 1 −1 1 −1 1 1 −1 1 −1 1 −1 −1 1 1 −1 −1 1 −1 −1 −1 1 −1 1 1 1 1 1 −1 −1 −1 −1 −1 −1 1 −1 1 1 −1 1 −1 −1 1 −1 −1 −1 1 −1 1 −1 1 −1 1 1 −1 −1 1 1 1 1 1 −1 1 −1 1 1 −1 1 1 1 1 −1 1 1 1 −1 −1 1 −1 −1 −1 1 −1 −1 −1 −1 −1 1 −1 −1 1 1 −1 −1 −1 1 1 −1 −1 1 1 1 −1 1 1 1 1 −1 −1 1 1 1 1 −1 1 −1 −1 1 −1 −1 1 −1 1 1 1 −1 1 1 1 −1 1 1 −1 −1 1 −1 1 1 −1 −1 −1 1 1 1 1 1 −1 1 −1 −1 1 1 1 1 −1 −1 1 −1 1 1 −1 1 1 1 1 −1 1 1 1 1 −1 1 −1 −1 −1 −1 1 1 1 1 −1 1 −1 1 −1 −1 −1 −1 −1 1 1 −1 1 1 1 1 −1 1 −1 1 −1 1 1 1 1 −1 −1 −1 −1 −1 1 −1 −1 1 1 1 −1 −1 1 −1 1 −1 −1 −1 1 1 1 1 −1 −1 −1 −1 1 −1 −1 −1 −1 −1 −1 −1 1 1 1 1 1 1 −1 1 1 1 −1 1 −1 1 1 1 1 −1 1 −1 1 −1 −1 −1 1 1 −1 −1 −1 1 −1 −1 −1 −1 1 −1 −1 −1 1 −1 −1 1 1 −1 −1 1 1 −1 −1 1 −1 1 1 1 1 −1 1 1 −1 1 −1 −1 −1 1 1 1 −1 −1 −1 1 1 −1 −1 1 1 1 −1 −1 1 −1 1 1 −1 1 1 1 −1 1 1 1 1 −1 −1 1 −1 1 1 −1 −1 1 −1 −1 1 1 1 −1 1 −1 1 −1 −1 −1 −1 −1 −1 −1 1 −1 1 1 −1 −1 1 1 −1 1 1 1 −1 1 −1 1 −1 −1 1 1 1 1 −1 1 −1 −1 −1 −1 1 1 1 −1 1 1 1 1 −1 1 1 −1 −1 1 1 1 1 1 −1 −1 1 −1 1 1 −1 1 −1 −1 1 1 −1 −1 −1 −1 1 −1 1 −1 −1 −1 1 −1 1 1 1 −1 1 −1 1 −1 1 1 −1 1 −1 1 −1 1 1 1 1 1 1 1 −1 −1 1 1 −1 −1 1 −1 1 1 1 −1 −1 −1 −1 1 −1 −1 −1 −1 −1 1 −1 1 −1 −1 −1 −1 1 1 1 1 1 1 −1 −1 1 1 −1 1 −1 −1 −1 −1 −1 1 1 −1 1 1 −1 1 1 1 1 1 −1 1 −1 −1 1 1 −1 1 −1 −1 −1 1 −1 1 −1 −1 −1 1 −1 −1 1 −1 1 1 −1 1 1 1 1 1 −1 −1 −1 −1 −1 1 1 1 −1 −1 1 −1 1 −1 1 1 −1 −1 1 1]; and
Sn10242=[1 1 −1 1 −1 −1 −1 1 1 −1 −1 −1 −1 −1 −1 −1 −1 1 −1 1 −1 −1 1 1 −1 −1 1 −1 −1 1 −1 −1 1 1 −1 −1 −1 1 −1 −1 1 −1 −1 −1 −1 1 1 1 1 1 −1 −1 1 1 −1 1 −1 1 1 1 1 1 1 −1 1 1 1 −1 −1 1 1 −1 −1 −1 −1 1 −1 1 1 1 1 −1 1 1 1 1 1 −1 1 −1 1 −1 −1 1 −1 1 −1 −1 1 −1 1 1 −1 1 1 1 1 −1 1 1 −1 −1 −1 −1 1 1 −1 1 1 −1 1 1 −1 1 −1 1 1 −1 −1 1 −1 −1 −1 1 −1 −1 −1 1 −1 −1 1 1 1 1 1 1 −1 −1 −1 −1 1 −1 −1 1 1 −1 1 1 1 −1 1 −1 1 1 −1 −1 −1 −1 −1 1 −1 1 1 −1 1 1 1 1 −1 −1 −1 −1 −1 1 1 1 −1 −1 1 1 −1 1 1 −1 −1 −1 1 −1 1 −1 −1 −1 1 −1 1 −1 −1 −1 1 −1 −1 −1 −1 1 −1 1 −1 1 −1 1 1 1 −1 −1 −1 −1 −1 1 −1 1 −1 1 1 1 1 −1 1 −1 −1 1 1 1 1 −1 1 1 1 1 −1 1 1 1 −1 1 −1 1 1 −1 1 −1 1 1 1 1 −1 −1 1 −1 −1 1 1 −1 1 1 −1 1 −1 1 −1 −1 −1 −1 −1 −1 −1 −1 −1 −1 1 −1 1 1 1 −1 1 1 1 1 1 1 1 −1 −1 −1 −1 1 −1 1 −1 −1 1 −1 −1 1 −1 −1 1 −1 −1 −1 −1 1 −1 1 −1 1 −1 −1 1 1 1 1 −1 −1 −1 1 −1 1 1 1 −1 1 −1 −1 −1 −1 1 −1 1 −1 −1 1 −1 −1 1 1 1 1 1 −1 −1 1 −1 −1 1 1 1 1 1 −1 1 1 −1 1 −1 1 1 1 −1 −1 1 −1 1 −1 1 −1 −1 1 −1 1 1 1 1 −1 −1 −1 −1 1 −1 −1 −1 1 1 −1 −1 1 1 1 −1 −1 1 −1 1 −1 1 −1 1 1 −1 −1 1 1 −1 −1 1 −1 1 −1 1 1 −1 1 −1 −1 −1 1 −1 1 −1 1 −1 −1 −1 −1 −1 −1 −1 −1 −1 1 −1 −1 −1 1 −1 1 1 −1 1 1 1 −1 1 1 −1 −1 1 −1 −1 −1 1 1 1 −1 1 −1 −1 −1 −1 −1 −1 1 1 1 −1 1 1 −1 −1 1 −1 −1 1 1 1 −1 −1 −1 1 1 1 −1 −1 −1 1 −1 −1 1 1 −1 1 1 −1 −1 −1 −1 1 1 −1 1 1 1 1 −1 1 −1 −1 −1 1 1 −1 −1 −1 1 1 −1 −1 −1 1 1 1 1 1 −1 −1 1 −1 −1 1 1 −1 −1 −1 −1 1 −1 1 1 −1 −1 1 −1 1 −1 1 −1 −1 1 −1 1 1 1 1 1 1 −1 −1 1 1 1 −1 −1 1 1 1 −1 −1 −1 −1 1 −1 1 −1 −1 1 −1 −1 1 −1 −1 −1 −1 1 1 −1 1 −1 1 1 −1 1 1 1 −1 1 1 −1 1 −1 −1 −1 1 1 −1 −1 −1 1 −1 −1 1 1 1 −1 −1 1 1 1 1 −1 1 1 1 1 −1 −1 −1 −1 1 1 1 −1 −1 −1 −1 −1 1 −1 −1 −1 1 −1 1 −1 −1 1 1 −1 1 −1 1 −1 1 −1 −1 1 −1 1 1 −1 −1 −1 −1 1 1 1 1 −1 −1 1 1 −1 1 −1 1 −1 1 1 −1 −1 1 1 1 −1 −1 −1 −1 1 −1 1 1 1 −1 1 1 −1 −1 −1 1 −1 −1 1 1 −1 1 1 −1 1 1 −1 −1 1 −1 −1 −1 −1 1 1 −1 1 −1 1 1 1 1 1 −1 1 1 1 1 −1 −1 −1 −1 1 −1 −1 −1 −1 1 1 1 −1 1 1 −1 1 1 1 1 1 1 −1 −1 −1 1 1 1 1 −1 1 1 1 1 1 1 1 1 1 −1 1 −1 −1 1 −1 1 1 −1 1 1 1 −1 1 1 1 1 −1 1 1 1 −1 −1 1 1 1 −1 1 1 1 1 −1 −1 1 1 −1 −1 −1 −1 1 1 1 −1 1 1 1 −1 −1 −1 −1 −1 −1 −1 −1 −1 1 1 −1 −1 −1 1 −1 1 −1 1 1 −1 1 1 −1 −1 1 −1 −1 −1 1 1 1 1 −1 −1 −1 1 1 −1 1 1 1 1 −1 1 1 −1 −1 −1 1 1 1 −1 1 1 −1 1 −1 1 1 1 1 −1 −1 1 −1 1 −1 −1 −1 1 1 −1 1 1 −1 −1 1 1 −1 1 1 1 1 −1 1 −1 1 1 −1 1 −1 1 1 −1 1 −1 1 1 1 1 −1 −1 1 1 1 1 −1 −1 −1 1 1 −1 −1 1 −1 −1 1 1 1 1 −1 −1 1 −1 1 1 1 −1 −1 1 1 −1 −1 1 1 −1 1 1 −1 −1 1 −1 1 1 1 1 1 1 1 −1 −1 −1 1 1 1 −1 −1 −1 1 1 −1 1 −1 −1 1 1 1 −1 1 −1 −1 1 1 1 1 −1 −1 1 −1 1 −1 −1 1 −1 1 1 −1 −1].

That is, in the binary sequence pair, x corresponds to Sn10241, and y corresponds to Sn10242.

In an embodiment, the sequence length of the binary sequence pair is 2048, and sequences corresponding to the binary sequence pair are:
Sn20481=[1 −1 1 1 1 −1 −1 −1 1 −1 1 −1 −1 1 −1 −1 1 1 −1 1 −1 1 1 1 1 −1 1 −1 1 −1 1 −1 1 1 1 1 1 1 −1 −1 −1 −1 1 −1 1 −1 1 −1 −1 1 −1 1 −1 1 1 1 −1 1 1 1 1 −1 1 1 1 1 −1 1 −1 −1 −1 1 −1 −1 −1 −1 1 1 −1 −1 −1 −1 1 1 −1 −1 −1 −1 1 −1 1 −1 −1 −1 1 −1 −1 1 1 1 1 −1 −1 −1 1 −1 −1 −1 1 −1 −1 1 1 −1 1 −1 −1 −1 1 1 −1 1 1 −1 −1 1 1 1 1 1 −1 −1 −1 −1 −1 −1 1 1 1 −1 1 1 −1 −1 −1 −1 −1 −1 −1 1 1 −1 1 −1 1 −1 −1 1 −1 1 −1 1 −1 −1 −1 −1 1 −1 1 1 1 1 1 1 1 1 −1 1 1 1 −1 1 −1 1 1 1 1 1 −1 −1 1 −1 −1 1 −1 −1 −1 −1 1 1 −1 −1 1 1 −1 1 1 1 1 1 1 1 −1 −1 −1 1 −1 1 1 −1 −1 1 1 1 1 1 1 −1 −1 1 −1 1 −1 −1 −1 −1 1 1 −1 −1 −1 1 1 1 1 −1 1 1 −1 −1 −1 −1 1 −1 −1 1 1 1 1 −1 1 1 1 −1 1 1 1 1 1 1 −1 1 1 −1 −1 1 −1 −1 −1 1 −1 −1 −1 −1 1 1 1 −1 1 −1 1 −1 −1 1 1 1 −1 1 −1 1 −1 1 −1 −1 1 −1 1 1 −1 −1 −1 1 −1 −1 1 1 1 1 −1 1 1 1 1 1 1 1 −1 −1 1 −1 1 1 −1 −1 1 1 −1 −1 1 −1 1 1 −1 1 −1 −1 1 1 −1 −1 1 −1 −1 −1 1 1 1 −1 1 1 −1 −1 −1 1 1 −1 1 1 1 −1 1 −1 −1 1 −1 1 1 −1 1 1 1 −1 −1 1 −1 1 1 1 1 −1 −1 1 −1 1 1 −1 −1 1 −1 1 1 −1 −1 −1 −1 −1 −1 −1 −1 −1 −1 −1 −1 1 1 1 −1 −1 1 1 −1 1 −1 −1 1 1 −1 1 1 −1 −1 −1 1 1 1 −1 1 −1 1 −1 1 −1 −1 −1 −1 1 1 −1 −1 1 1 1 1 1 1 −1 1 −1 1 −1 −1 1 −1 1 1 1 1 1 1 −1 −1 1 −1 −1 −1 −1 1 1 1 1 −1 −1 −1 −1 1 −1 −1 −1 1 −1 1 −1 1 −1 1 −1 −1 1 1 −1 −1 1 −1 1 1 1 −1 1 1 −1 −1 1 1 −1 −1 −1 1 1 −1 −1 1 −1 1 1 1 −1 1 1 −1 1 1 −1 −1 −1 −1 1 −1 −1 1 −1 −1 −1 −1 1 1 −1 −1 −1 1 1 −1 −1 1 −1 −1 −1 −1 −1 1 −1 1 1 1 −1 1 −1 −1 1 −1 −1 1 −1 −1 −1 1 1 1 −1 1 1 1 −1 −1 1 −1 1 −1 1 1 −1 1 −1 −1 −1 1 1 −1 −1 1 −1 1 −1 1 −1 −1 1 −1 1 −1 −1 1 1 1 −1 −1 −1 1 −1 1 −1 −1 1 1 1 −1 1 1 1 −1 −1 −1 1 −1 1 −1 1 −1 −1 1 −1 1 −1 1 1 −1 −1 1 −1 1 1 −1 1 1 1 1 1 −1 1 −1 −1 1 −1 1 −1 1 1 1 1 −1 −1 1 −1 1 1 1 −1 −1 1 −1 1 1 −1 −1 1 −1 −1 −1 −1 −1 1 −1 1 −1 −1 1 1 1 −1 1 1 −1 1 −1 1 −1 −1 1 1 1 1 −1 −1 1 1 −1 −1 −1 −1 1 −1 −1 −1 1 1 1 −1 1 1 1 −1 −1 1 1 −1 1 −1 1 −1 1 −1 −1 −1 1 −1 −1 1 1 1 −1 1 1 −1 −1 1 1 −1 −1 −1 −1 1 −1 −1 −1 −1 −1 1 −1 1 −1 −1 −1 1 −1 −1 1 −1 −1 1 −1 1 −1 1 −1 1 −1 1 1 −1 1 −1 1 −1 1 −1 −1 1 −1 1 1 1 1 1 −1 1 −1 1 −1 1 1 −1 −1 −1 −1 1 −1 1 1 1 1 −1 1 1 1 1 −1 1 1 1 −1 −1 1 1 −1 1 1 1 −1 −1 −1 1 −1 1 1 −1 −1 −1 −1 −1 1 −1 1 −1 −1 −1 1 −1 1 −1 −1 −1 1 −1 −1 1 −1 1 −1 1 −1 −1 −1 −1 −1 −1 1 1 1 −1 −1 1 1 −1 −1 −1 1 −1 1 1 −1 −1 1 1 1 −1 1 1 1 1 1 1 1 1 1 1 1 1 −1 −1 1 1 1 1 1 1 −1 1 1 −1 1 −1 1 −1 1 −1 −1 1 1 1 −1 1 −1 −1 1 −1 1 −1 1 −1 1 1 −1 1 −1 1 1 1 1 −1 1 −1 −1 1 −1 −1 −1 −1 −1 −1 −1 1 1 1 1 −1 −1 1 1 −1 1 1 1 1 −1 −1 1 −1 1 −1 −1 1 1 −1 1 1 −1 −1 1 1 1 1 −1 1 1 −1 1 −1 1 −1 1 1 −1 1 1 −1 1 −1 1 −1 −1 1 1 1 −1 1 1 −1 1 1 −1 1 1 −1 1 1 −1 1 −1 1 −1 −1 1 1 −1 1 1 1 1 1 −1 −1 −1 1 −1 1 −1 1 −1 −1 1 1 −1 −1 1 −1 −1 1 −1 1 −1 1 −1 −1 −1 1 −1 −1 −1 1 1 −1 −1 1 1 1 −1 1 −1 −1 −1 −1 −1 −1 1 −1 1 1 1 −1 −1 −1 1 1 −1 −1 −1 1 −1 1 1 −1 1 −1 −1 −1 −1 1 1 −1 1 1 −1 −1 −1 −1 −1 −1 1 1 1 1 −1 −1 −1 1 1 1 −1 1 1 −1 −1 1 −1 −1 1 1 −1 −1 −1 −1 1 −1 1 1 1 −1 1 1 −1 1 1 −1 −1 −1 −1 −1 1 −1 −1 −1 1 −1 −1 1 1 −1 −1 −1 1 1 1 1 1 1 −1 1 1 1 1 −1 1 −1 1 −1 1 −1 1 1 1 −1 1 1 1 −1 1 −1 −1 −1 1 1 −1 −1 −1 1 1 −1 −1 1 −1 −1 1 −1 1 −1 1 −1 −1 −1 −1 1 −1 −1 1 −1 1 −1 −1 1 −1 −1 −1 −1 1 1 1 1 1 1 1 1 1 1 −1 1 1 −1 −1 1 −1 −1 1 −1 −1 −1 −1 −1 1 1 −1 1 1 1 −1 −1 −1 −1 1 −1 −1 1 1 −1 −1 −1 1 −1 1 −1 1 1 1 −1 −1 1 −1 1 1 1 1 −1 −1 −1 −1 −1 1 −1 −1 1 −1 −1 1 −1 −1 1 −1 1 1 −1 1 −1 −1 −1 1 1 1 −1 1 1 1 1 −1 −1 1 1 1 −1 −1 1 −1 −1 −1 −1 −1 −1 −1 −1 −1 −1 −1 −1 1 −1 1 1 1 1 −1 1 −1 −1 −1 −1 −1 −1 −1 1 1 1 1 −1 −1 1 −1 −1 −1 −1 1 1 −1 1 1 1 −1 1 1 −1 −1 −1 −1 −1 −1 1 1 1 −1 −1 −1 −1 1 1 1 −1 −1 −1 −1 −1 −1 1 1 −1 1 1 −1 1 −1 −1 1 1 1 −1 −1 1 −1 −1 1 1 1 −1 1 1 −1 −1 −1 1 1 −1 1 1 1 −1 1 1 1 1 −1 1 1 1 −1 −1 1 −1 −1 1 −1 1 1 −1 −1 −1 −1 1 1 1 1 −1 1 1 1 1 1 −1 1 −1 −1 −1 −1 1 −1 1 −1 −1 −1 −1 1 −1 −1 1 1 −1 1 1 −1 1 1 −1 −1 −1 −1 1 −1 1 −1 −1 1 −1 −1 −1 −1 −1 1 1 −1 −1 1 1 −1 1 1 −1 −1 −1 −1 1 −1 −1 −1 −1 −1 1 1 −1 1 −1 −1 1 −1 −1 1 1 1 1 1 −1 −1 −1 −1 −1 −1 1 −1 1 1 −1 1 −1 −1 −1 1 −1 −1 1 1 1 1 −1 −1 −1 1 −1 1 −1 1 −1 −1 1 1 −1 1 −1 −1 1 −1 −1 1 −1 −1 1 1 1 −1 1 −1 1 1 1 −1 1 1 −1 −1 1 −1 1 −1 −1 −1 1 1 1 −1 −1 −1 1 −1 −1 −1 1 1 −1 −1 −1 −1 −1 1 −1 −1 1 1 −1 1 −1 −1 −1 1 −1 −1 1 −1 −1 1 1 −1 −1 −1 1 −1 −1 −1 −1 1 −1 −1 1 1 1 1 −1 1 1 −1 −1 1 −1 1 −1 1 −1 −1 −1 −1 1 1 1 −1 1 1 −1 −1 −1 1 −1 −1 1 1 1 1 1 −1 −1 −1 1 −1 −1 −1 1 −1 1 −1 −1 −1 1 1 1 1 1 −1 −1 −1 −1 −1 −1 −1 −1 1 1 1 1 1 1 1 −1 −1 1 1 −1 1 1 1 1 1 1 1 −1 1 −1 1 1 −1 1 1 1 1 −1 −1 1 1 −1 1 1 −1 −1 −1 −1 −1 −1 1 1 −1 1 1 1 1 −1 1 1 1 −1 1 1 −1 1 1 −1 1 −1 −1 1 1 1 −1 1 1 1 −1 −1 1 1 −1 1 1 1 −1 −1 −1 −1 1 1 −1 −1 −1 −1 1 −1 −1 −1 −1 1 −1 1 −1 1 1 −1 1 −1 1 1 −1 1 1 −1 −1 1 1 1 1 1 1 1 1 −1 −1 −1 −1 1 1 −1 −1 −1 −1 1 −1 −1 1 1 1 −1 1 −1 −1 1 1 1 −1 1 1 −1 −1 −1 −1 −1 −1 −1 1 −1 1 −1 1 1 −1 −1 1 −1 1 1 −1 1 1 1 1 −1 1 −1 −1 1 1 −1 −1 −1 −1 −1 −1 1 1 1 1 1 −1 1 −1 1 1 1 1 −1 −1 −1 1 1 1 1 −1 1 1 1 1 −1 −1 −1 1 −1 −1 1 −1 1 −1 −1 −1 1 −1 −1 1 −1 −1 −1 −1 1 −1 −1 −1 −1 1 −1 −1 1 1 1 −1 1 1 1 −1 1 1 1 1 −1 1 1 −1 −1 −1 −1 −1 1 1 −1 −1 −1 −1 1 1 1 −1 1 1 1 1 −1 −1 1 1 −1 1 1 −1 −1 −1 −1 −1 −1 1 1 1 1 1 1 1 1 1 1 −1 −1 1 −1 1 1 −1 −1 1 −1 1 1 −1 1 1 1 −1 −1 −1 −1 1 −1 −1 1 1 1 −1 1 −1 1 1 −1 −1 −1 1 −1 1 −1 −1 −1 1 1 1 −1 1 1 −1 1 −1 −1 −1 −1 −1 −1 −1 1]; and
Sn20482=[−1 −1 −1 1 1 −1 1 1 1 1 −1 −1 −1 −1 −1 1 1 −1 −1 −1 1 1 −1 1 −1 −1 1 1 −1 −1 1 −1 1 −1 1 1 −1 −1 −1 −1 −1 −1 −1 1 −1 1 −1 −1 −1 −1 −1 1 1 1 −1 1 1 −1 1 1 −1 −1 −1 1 1 1 −1 −1 −1 −1 −1 1 1 1 −1 −1 −1 −1 −1 −1 −1 1 −1 1 −1 −1 −1 −1 −1 −1 1 1 −1 1 1 −1 1 −1 −1 −1 −1 1 −1 −1 1 −1 1 −1 1 1 1 −1 −1 −1 −1 1 −1 −1 1 −1 1 1 −1 −1 1 1 1 1 1 −1 −1 1 1 1 −1 1 −1 1 −1 −1 −1 −1 1 1 1 −1 −1 −1 1 1 1 1 −1 1 −1 1 −1 1 −1 1 −1 1 1 1 1 1 1 −1 −1 1 −1 1 −1 −1 −1 −1 1 −1 −1 1 −1 −1 −1 1 1 −1 1 1 −1 −1 1 −1 −1 −1 −1 1 1 −1 −1 1 −1 −1 1 1 1 1 1 −1 1 1 −1 −1 −1 1 1 1 −1 −1 1 1 1 −1 −1 −1 1 1 1 1 −1 −1 1 −1 1 −1 −1 −1 −1 1 −1 −1 1 1 −1 −1 −1 1 1 −1 −1 1 1 1 1 −1 1 1 −1 1 −1 −1 1 −1 −1 1 1 −1 1 −1 1 −1 −1 1 −1 1 1 −1 1 −1 −1 1 −1 1 −1 1 1 1 −1 1 1 1 −1 1 −1 −1 1 1 −1 −1 −1 1 −1 −1 1 −1 1 −1 1 1 −1 −1 −1 −1 −1 −1 −1 −1 −1 1 −1 1 −1 1 1 1 −1 1 −1 1 −1 −1 1 −1 −1 1 1 −1 −1 1 −1 −1 −1 −1 −1 1 −1 −1 1 −1 −1 1 −1 1 −1 1 −1 −1 −1 −1 −1 1 −1 −1 −1 1 1 1 −1 1 1 −1 1 1 1 −1 −1 1 −1 −1 1 1 1 1 −1 −1 1 −1 −1 1 1 1 1 −1 1 −1 1 1 −1 −1 1 −1 −1 1 1 −1 1 −1 1 −1 1 −1 −1 −1 −1 −1 1 1 1 −1 1 −1 1 −1 −1 −1 −1 −1 −1 −1 −1 −1 −1 1 −1 1 1 −1 1 −1 1 1 1 1 −1 1 1 1 −1 −1 1 1 1 −1 −1 −1 1 1 1 1 1 1 −1 −1 1 −1 −1 −1 1 −1 1 1 1 −1 −1 1 −1 −1 −1 1 −1 −1 1 −1 1 1 1 −1 −1 1 1 1 −1 1 −1 −1 1 1 1 1 −1 1 1 −1 1 −1 1 −1 −1 1 1 1 1 −1 −1 −1 −1 1 1 1 1 −1 −1 −1 −1 −1 1 −1 −1 1 −1 1 −1 −1 −1 −1 −1 1 −1 1 −1 1 1 1 1 1 1 1 −1 1 −1 −1 −1 1 −1 −1 −1 −1 −1 −1 −1 −1 −1 1 1 −1 1 −1 −1 −1 1 −1 −1 1 −1 −1 1 1 1 −1 −1 −1 −1 −1 −1 −1 −1 1 1 −1 −1 1 −1 1 1 −1 1 1 1 1 1 1 1 −1 1 −1 −1 1 −1 −1 1 1 1 1 −1 −1 1 1 −1 1 −1 −1 −1 −1 −1 1 1 1 1 −1 −1 −1 1 −1 −1 −1 −1 1 −1 1 1 1 −1 1 −1 −1 −1 −1 −1 1 −1 −1 −1 −1 1 −1 1 1 1 1 −1 1 −1 −1 1 −1 −1 −1 1 1 −1 1 −1 −1 −1 −1 1 −1 −1 1 −1 1 1 1 −1 −1 −1 −1 1 1 −1 −1 1 −1 −1 −1 1 1 −1 1 −1 −1 1 1 −1 −1 1 −1 −1 −1 1 1 1 1 1 −1 −1 1 1 −1 1 1 1 1 −1 −1 1 −1 1 −1 −1 1 1 1 1 1 −1 −1 1 1 1 1 1 −1 −1 1 −1 1 1 −1 −1 −1 −1 −1 1 −1 −1 1 1 −1 1 −1 −1 −1 1 −1 1 −1 1 −1 1 −1 1 −1 1 −1 −1 −1 −1 1 1 1 −1 −1 −1 1 1 1 1 1 −1 −1 1 −1 −1 1 −1 −1 1 −1 −1 1 −1 −1 1 1 1 −1 −1 −1 1 1 −1 −1 1 1 −1 −1 1 −1 1 1 1 −1 1 −1 1 1 −1 1 −1 −1 1 1 1 1 1 1 −1 1 1 1 −1 −1 1 −1 1 1 1 −1 −1 1 1 1 −1 −1 1 −1 −1 −1 1 1 −1 −1 1 −1 1 1 1 1 −1 1 1 1 1 1 1 1 1 1 −1 1 1 −1 1 −1 −1 1 −1 1 1 1 1 −1 −1 1 1 −1 −1 1 1 −1 −1 1 1 −1 1 1 1 1 −1 −1 1 1 −1 −1 1 −1 1 1 1 −1 1 −1 1 −1 −1 1 1 1 −1 −1 1 −1 −1 −1 −1 −1 −1 1 −1 −1 1 1 1 −1 1 −1 −1 1 1 1 −1 1 −1 1 −1 1 1 −1 −1 1 −1 −1 1 1 −1 −1 −1 −1 −1 1 −1 1 1 −1 −1 −1 −1 1 1 1 1 −1 −1 −1 1 −1 1 1 1 −1 −1 −1 1 1 1 −1 1 −1 1 −1 −1 −1 −1 1 −1 −1 −1 1 1 1 1 1 −1 −1 1 1 −1 −1 −1 −1 1 −1 1 −1 −1 −1 1 −1 −1 1 1 1 1 −1 −1 −1 1 1 1 1 −1 1 1 1 1 −1 −1 1 1 1 −1 1 1 1 1 −1 −1 1 1 −1 1 −1 1 −1 −1 1 −1 −1 1 1 −1 1 1 1 −1 1 1 −1 1 1 1 −1 −1 1 1 1 1 −1 1 1 1 −1 1 1 1 1 1 −1 −1 −1 −1 1 1 1 1 −1 −1 −1 1 −1 1 −1 −1 −1 −1 −1 1 1 1 1 −1 −1 −1 1 −1 1 −1 −1 1 −1 1 −1 1 −1 −1 −1 1 −1 1 1 −1 1 −1 −1 −1 −1 1 1 −1 1 1 1 1 1 1 1 −1 1 1 1 1 1 −1 −1 1 −1 −1 1 1 −1 −1 −1 −1 1 −1 −1 1 1 1 −1 −1 −1 −1 −1 1 1 −1 1 1 −1 1 −1 1 −1 1 −1 1 1 −1 −1 −1 1 1 −1 −1 1 −1 1 −1 1 −1 −1 1 1 −1 1 −1 1 1 1 1 1 1 1 1 −1 −1 −1 1 1 −1 −1 1 1 1 1 −1 −1 1 1 −1 1 1 1 1 −1 −1 −1 −1 1 −1 1 1 1 1 1 −1 1 1 1 −1 1 −1 −1 1 −1 1 1 −1 −1 −1 −1 1 1 −1 1 1 −1 1 1 1 1 1 1 −1 −1 1 1 1 −1 −1 1 1 1 1 1 1 −1 −1 −1 1 −1 1 1 1 1 −1 1 −1 1 −1 1 −1 1 1 1 −1 −1 −1 −1 1 −1 1 −1 1 1 −1 −1 −1 1 1 1 1 −1 1 −1 1 1 1 −1 1 −1 1 −1 1 1 1 −1 1 −1 −1 −1 −1 −1 −1 1 −1 1 1 −1 1 −1 −1 1 1 −1 −1 −1 1 1 −1 1 1 1 1 −1 1 −1 −1 −1 1 1 1 1 1 −1 −1 1 −1 −1 1 −1 1 1 1 −1 1 1 −1 1 1 −1 1 1 −1 1 1 1 1 −1 −1 −1 −1 1 1 −1 1 −1 −1 −1 1 1 1 1 1 1 −1 1 1 1 −1 −1 −1 1 −1 −1 1 −1 −1 −1 1 −1 1 −1 −1 −1 −1 1 −1 −1 −1 1 1 1 1 −1 1 −1 1 −1 1 −1 1 −1 −1 −1 1 −1 1 −1 1 −1 −1 1 1 −1 −1 −1 1 1 1 1 −1 1 −1 −1 1 1 −1 1 −1 −1 1 −1 −1 −1 −1 1 −1 −1 1 −1 −1 −1 1 −1 −1 1 −1 1 −1 1 1 −1 1 1 1 −1 −1 −1 −1 −1 1 1 −1 1 −1 1 1 −1 1 1 −1 1 −1 −1 1 −1 −1 −1 1 −1 1 −1 1 −1 −1 1 1 −1 1 −1 1 −1 −1 1 −1 −1 −1 −1 1 −1 −1 1 −1 −1 1 1 −1 −1 1 −1 1 −1 −1 −1 −1 −1 1 1 1 1 1 1 1 −1 1 1 1 1 1 −1 −1 −1 1 1 1 −1 −1 −1 1 1 −1 1 1 1 −1 −1 −1 −1 −1 1 −1 −1 −1 1 1 −1 1 1 1 −1 1 1 −1 −1 −1 −1 1 −1 −1 −1 −1 −1 1 −1 1 1 −1 −1 1 −1 −1 1 1 −1 1 −1 −1 −1 −1 −1 −1 1 −1 −1 −1 1 −1 1 1 −1 −1 −1 1 −1 −1 1 −1 −1 1 1 −1 −1 −1 −1 1 1 1 −1 −1 1 1 1 111 1 −1 −1 −1 −1 −1 −1 1 −1 −1 1 1 −1 1 1 −1 1 −1 −1 1 −1 1 −1 −1 1 1 1 1 −1 1 1 1 −1 1 1 1 −1 −1 1 1 −1 1 −1 −1 −1 1 −1 −1 −1 1 1 −1 −1 −1 1 −1 1 −1 −1 1 1 −1 1 1 −1 −1 −1 1 1 1 1 1 1 1 −1 1 1 1 1 1 −1 −1 1 −1 −1 1 −1 1 −1 1 −1 −1 1 −1 1 −1 −1 1 1 1 −1 −1 1 1 1 1 −1 −1 −1 −1 −1 1 1 1 −1 −1 1 1 −1 −1 −1 −1 1 −1 1 −1 1 −1 −1 −1 1 −1 −1 −1 1 1 1 1 1 −1 1 1 1 −1 −1 1 −1 1 −1 1 1 1 1 1 −1 −1 −1 1 1 1 1 −1 −1 1 1 1 1 −1 1 1 1 1 1 1 −1 −1 1 1 −1 −1 −1 1 1 1 −1 1 −1 −1 1 −1 −1 1 1 −1 −1 −1 1 −1 −1 −1 1 −1 1 1 −1 1 1 −1 1 −1 −1 −1 1 1 −1 −1 1 1 −1 −1 −1 1 −1 1 −1 1 1 1 −1 1 1 −1 −1 −1 1 −1 1 −1 1 −1 −1 1 1 1 1 −1 −1 −1 −1 −1 −1 −1 1 −1 −1 1 −1 1 −1 1 1 −1 −1 −1 −1 1 1 1 1 −1 1 −1 1 −1 −1 −1 1 1 1 −1 1 −1 1 −1 −1 1 −1 1 −1 1 −1 1 −1 1 −1 −1 −1 1 −1 −1 1 1 1 −1 1 −1 1 −1 1 −1 1 1 −1 −1 −1 −1 1 1 1 −1 −1 −1 1 1 1 −1 −1 −1 −1 −1 1 −1 1 1 1 1 −1 1 1 1 1 1 −1 −1 1 1 1 1 −1 1 1 1 −1 −1 1 −1 1].

That is, in the binary sequence pair, x corresponds to Sn20481, and y corresponds to Sn20482. Based on the foregoing embodiment, the binary sequence pair is used as a base sequence used for generating a sensing sequence, and a design principle of the binary sequence pair is that a local area has a low autocorrelation and a low cross-correlation. The low autocorrelation means that a sum of autocorrelations of the binary sequence pair in the local area is close to zero at a location other than 0, and the low cross-correlation means that a cross-correlation in the area is also close to zero. The sum of the autocorrelations means that autocorrelation is separately performed on two sequences of the binary sequence pair, and then summation is performed. A location of 0 is a location at which the two sequences are completely aligned. The sensing sequence generated based on the binary sequence pair with the low autocorrelation and the low cross-correlation has high Doppler tolerance and good target sensing performance Specifically, in response to the sensing sequence being used for sensing, a self-ambiguity function model of the sensing sequence shows that a main lobe (the location 0) of the sequence autocorrelation remains stable under any Doppler frequency offset. This indicates that the sensing sequence in embodiments described herein has high Doppler tolerance during target sensing. In addition, the self-ambiguity function model shows that the sequence autocorrelation is close to zero in a local range (a location other than 0) under any Doppler offset. This indicates that at least one embodiment facilitates better implementation of target sensing. A mutual ambiguity function model shows that a mutual ambiguity function value is low, which indicates that mutual interference between sensing sequences is small. This indicates better target sensing. In addition, for the “local area” mentioned above, for example, in response to a scope of an actual application scenario in the field of target sensing technologies and a speed of a single-carrier physical layer in an existing high frequency standard being 1.76 Gbps being considered, a range of the local area in the foregoing design criterion is set to ±128. The local area corresponds to ±21.82 meters in an actual scenario, and in a case of self-receiving and self-sending, the local area corresponds to ±10.91 meters in the actual scenario. A value of the range of the local area meets an application scenario in an existing high frequency related standard. The foregoing “±128” indicates that in response to a binary sequence pair in the range of the area being generated, one sequence remains unchanged, and the other sequence moves 128 (−128) to the left and 128 (+128) to the right.

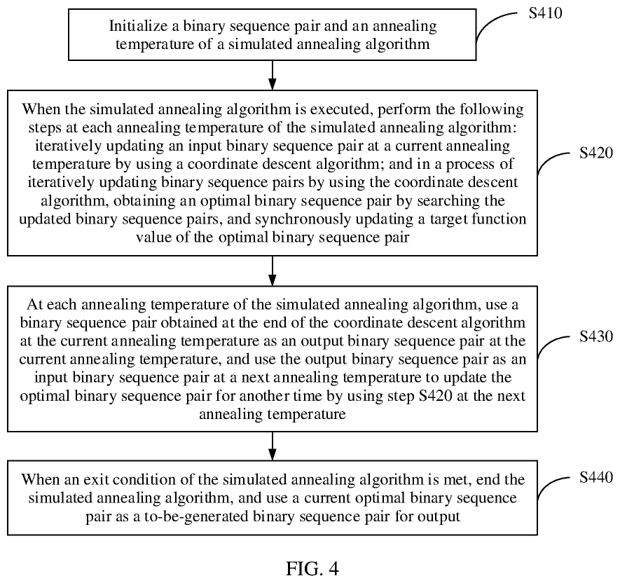

Further, the following describes in detail a method for generating the foregoing binary sequence pair provided in at least one embodiment with reference to the accompanying drawings. As shown in FIG. 4, the method for generating the foregoing binary sequence pair provided in at least one embodiment mainly includes the following steps.
S410: Initialize the binary sequence pair and an annealing temperature of a simulated annealing algorithm.

Specifically, a length of the initialized binary sequence pair is a length of a to-be-obtained binary sequence pair. For example, in response to the length of the to-be-obtained binary sequence pair being 256 bits, the length of the initialized binary sequence pair is 256 bits.
S420: In response to the simulated annealing algorithm being executed, perform the following steps at each annealing temperature of the simulated annealing algorithm: iteratively updating an input binary sequence pair at a current annealing temperature by using a coordinate descent algorithm; and in a process of iteratively updating binary sequence pairs by using the coordinate descent algorithm, obtaining an optimal binary sequence pair by searching the updated binary sequence pairs, and synchronously updating a target function value of the optimal binary sequence pair.

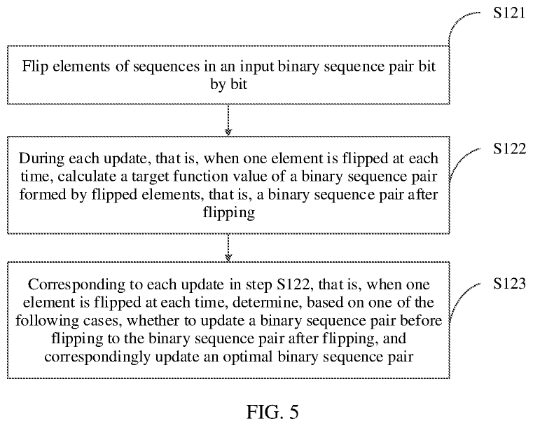

In some embodiments, in a flowchart shown in FIG. 5, step S420 includes the following substeps S121 to S123.
S121: Flip elements of sequences in the input binary sequence pair bit by bit, where each flipped element corresponds to one update in one iterative update in which the coordinate descent algorithm is used.
S122: During each update, that is, in response to one element being flipped at each time, calculate a target function value of a binary sequence pair formed by flipped elements, that is, a binary sequence pair after flipping. Calculation of the target function value includes the following two steps.
Step 1: Calculate an autocorrelation function and a cross-correlation function of each sequence in the binary sequence pair after flipping according to the following formulas.

The autocorrelation function is calculated according to the following formula:

$${C}_{x} ( k ) = \{ \begin{matrix}{C}_{x}^{′} ( k ) - 2 {x}_{i} {x}_{i + k} & \begin{matrix}1 \leq i \leq k \\ and i \leq L - k\end{matrix} ; \\ {C}_{x}^{′} ( k ) - 2 {x}_{i} ( {x}_{i - k} + {x}_{i + k} ) & k + 1 \leq i \leq L - k ; \\ {C}_{x}^{′} ( k ) - 2 {x}_{i - k} {x}_{i} & \begin{matrix}L - k + 1 \leq i \leq L \\ and i \geq k + 1\end{matrix} ; \\ {C}_{x}^{′} ( k ) & otherwise\end{matrix} .$$

C′ₓ(k) is an autocorrelation function value before an i^{th} element of a sequence x in the binary sequence pair is flipped.

Cₓ(k) is an autocorrelation function value after the i^{th} element of the sequence x is flipped.

xᵢ indicates the i^{th} element of the sequence x, k indicates a delay, xᵢ₋ₖ indicates an (i−k)^{th} element of the sequence x, xᵢ₊ₖ indicates an (i+k)^{th} element of the sequence x, and L indicates a length of the sequence x.

The cross-correlation function is calculated according to the following formulas.

After an i^{th} element of a sequence x is flipped, a cross-correlation function between the sequence x and a sequence y is:

$${C}_{xy} ( k ) = \{ \begin{matrix}{C}_{xy}^{′} ( k ) - 2 {x}_{i} {y}_{i + k} & \begin{matrix}0 \leq k \leq L - i \\ or - i \leq k \leq 0\end{matrix} \\ {C}_{xy}^{′} ( k ) & otherwise\end{matrix} .$$

After an i^{th} element of a sequence y is flipped, a cross-correlation function between a sequence x and the sequence y is:

$${C}_{xy} ( k ) = \{ \begin{matrix}{C}_{xy}^{′} ( k ) - 2 {x}_{i - k} {y}_{i} , & 0 \leq k \leq i \\ {C}_{xy}^{′} ( k ) , & \begin{matrix}or i - L \leq k < 0 \\ otherwise\end{matrix}\end{matrix} .$$

C′_{xy}(k) is a cross-correlation function value before the sequence x or the sequence y is flipped.

C_{xy}(k) is a cross-correlation function value after the sequence x or the sequence y is flipped.

k indicates a delay, xᵢ indicates the i^{th} element of the sequence x, yᵢ indicates the i^{th} element of the sequence y, and yᵢ₊ₖ indicates an (i+k)^{th} element of the sequence y.
Step 2: Calculate a target function of the binary sequence pair after flipping according to the following formula.

The target function value is calculated according to the following formula:

$$\begin{matrix}{min}_{x , y} α & {\sum }_{k = 1}^{L - 1} {w}_{k} {\vert {C}_{x} ( k ) + {C}_{y} ( k ) \vert}^{2} + ( 1 - α ) {\sum }_{k = 0}^{L - 1} {\tilde{w}}_{k} {\vert {C}_{xy} ( k ) \vert}^{2} \\ s . t . & \vert {x}_{k} \vert = 1 , k = 0 , 1 , … , L - 1 , \\ & \vert {x}_{k} \vert = 1 , k = 0 , 1 , … , L - 1 ,\end{matrix} .$$

Cₓ(k) indicates the autocorrelation function of the sequence x.

C_{y}(k) indicates the autocorrelation function of the sequence y.

C_{xy}(k) indicates the cross-correlation function of x and y.

xₖ indicates a k^{th} element of x, and yₖ indicates a k^{th} element of y, where

$${w}_{k} = \{ \begin{matrix}1 , & k = - Z + 1 , … , - 1 , 1 , … , Z - 1 \\ 0 , & k = - L + 1 , … , - Z , Z , … , L - 1\end{matrix} .$$

S123: Corresponding to each update in step S122, that is, in response to one element being flipped at each time, determine, based on one of the following cases, whether to update the binary sequence pair before flipping to the binary sequence pair after flipping, and correspondingly update the optimal binary sequence pair:
(A) In response to the target function value of the binary sequence pair after flipping being not greater than a target function value of the binary sequence pair before current flipping, the binary sequence pair before flipping is updated to the binary sequence pair after flipping. In other words, the update of the binary sequence pair in the current iteration is accepted (that is, flipping of the element in the current iteration is received). In addition, the optimal binary sequence pair is updated to the binary sequence pair after flipping (that is, the optimal binary sequence pair is used as an intermediate value to record the binary sequence pair obtained after the current update is accepted), and the target function value of the binary sequence pair after flipping is recorded, that is, a target function value of a currently updated optimal binary sequence pair is recorded.
(B) In response to the target function value of the binary sequence pair after flipping being greater than a target function value of the binary sequence pair before current flipping, and an acceptance probability function value is less than a value, the binary sequence pair before flipping is updated to the binary sequence pair after flipping (that is, current flipping of the element is accepted at a specific probability). In addition, the target function value is updated to the target function value of the binary sequence pair after flipping. In this case, the optimal binary sequence pair is not updated (that is, the optimal binary sequence pair is still the binary sequence pair before flipping).
(C) In response to the target function value of the binary sequence pair after flipping being greater than a target function value of the binary sequence pair before current flipping, and an acceptance probability function value is greater than or equal to a value, the binary sequence pair before current flipping is not updated (that is, the binary sequence pair after current flipping is updated to the binary sequence pair before current flipping, and current flipping of the element is not accepted). In this case, neither a target function value of the optimal binary sequence pair nor the target function value of the binary sequence pair is updated. In other words, both the target function value of the optimal binary sequence pair and the target function value of the binary sequence pair are correlation values of the binary sequence pair before flipping.

The acceptance probability function is

$$P = {e}^{- \frac{( f - {f}_{0} )}{T}} .$$

P is the acceptance probability function value, f is the target function value of the binary sequence pair after flipping, f₀ is the target function value of the binary sequence pair before flipping (that is, the target function value of the optimal binary sequence pair before being updated), and T is the current annealing temperature of the simulated annealing algorithm. A value compared with the acceptance probability function value is a random number between [0,1], or is a preset value.

In the foregoing steps, whether recording (record by using the optimal binary sequence pair) the update of the binary sequence pair in the current iteration process is determined based on a greedy search probability (that is, the foregoing acceptance probability) designed according to a simulated annealing algorithm criterion and a value relationship between target function values in two iteration processes. In this way, convergence of a target function is ensured, and the annealing temperature of the simulated annealing algorithm is used as a determining condition for iteratively updating the binary sequence pair by using the coordinate descent algorithm. This prevents the obtained binary sequence pair from falling into local optimality, and a binary sequence pair with a good local autocorrelation and cross-correlation is found.
S430: At each annealing temperature of the simulated annealing algorithm, use a binary sequence pair obtained at the end of the coordinate descent algorithm at the current annealing temperature as an output binary sequence pair at the current annealing temperature, and use the output binary sequence pair as an input binary sequence pair at a next annealing temperature to update the optimal binary sequence pair for another time by using step S420 at the next annealing temperature.
S440: In response to an exit condition of the simulated annealing algorithm being met, end the simulated annealing algorithm, and use a current optimal binary sequence pair as a to-be-generated binary sequence pair for output.

In some embodiments, the exit condition is one of the following:
exit condition 1: Annealing temperatures of the simulated annealing algorithm gradually decrease and reach a preset minimum threshold of the annealing temperatures;
exit condition 2: Annealing temperatures continuously decrease, and target function values of output binary sequence pairs at the annealing temperatures are stable; or
exit condition 3: Annealing temperatures continuously decrease, target function values of output binary sequence pairs at the annealing temperatures are stable, and the current annealing temperature is lower than a preset value.

In response to the target function values of the output binary sequence pairs at the annealing temperatures that continuously decrease being stable, the optimal binary sequence pair is stable. Therefore, the simulated annealing algorithm is exited, and the current optimal binary sequence pair is used as the to-be-generated binary sequence pair for output.

It should be noted that, that the target function values of the output binary sequence pairs are stable means that at annealing temperatures that continuously decrease for a specific quantity of times, the target function values of the output binary sequence pairs at the annealing temperatures do not change or change less than a threshold.

In at least one embodiment, the simulated annealing algorithm and the coordinate descent algorithm are combined to generate the binary sequence pair. This ensures that the target function value of the binary sequence pair converges to a stable value, and the optimal binary sequence pair is found. In addition, at least one embodiment a method for quickly calculating a target function value, so that complexity O(L²) of calculating the target function is reduced to linear complexity O(L).

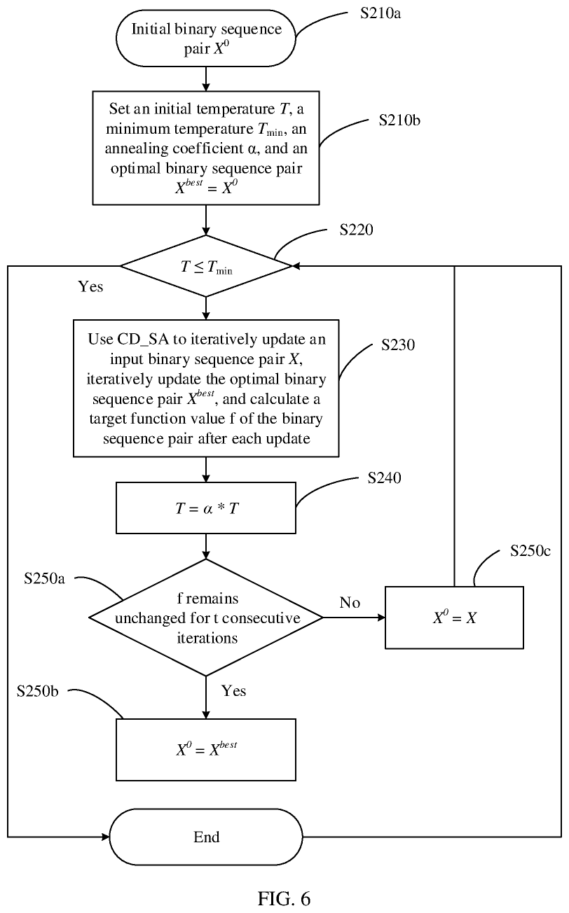

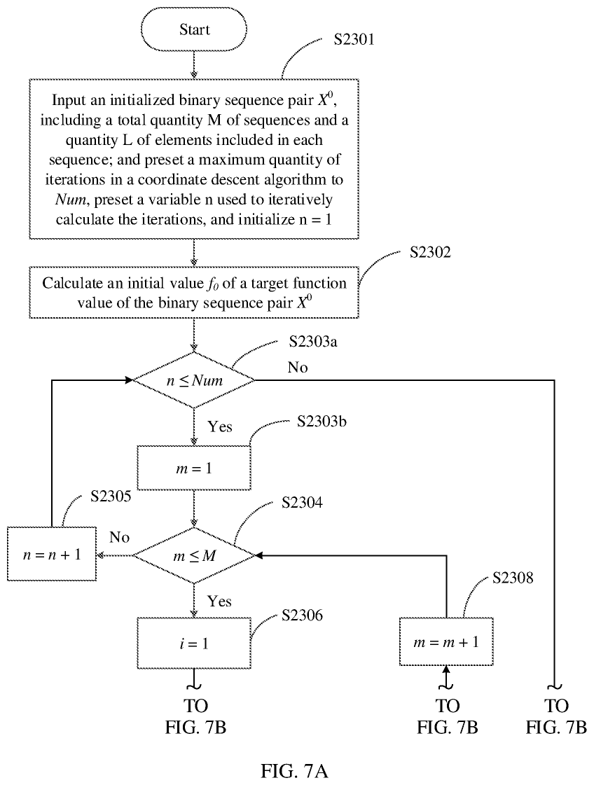

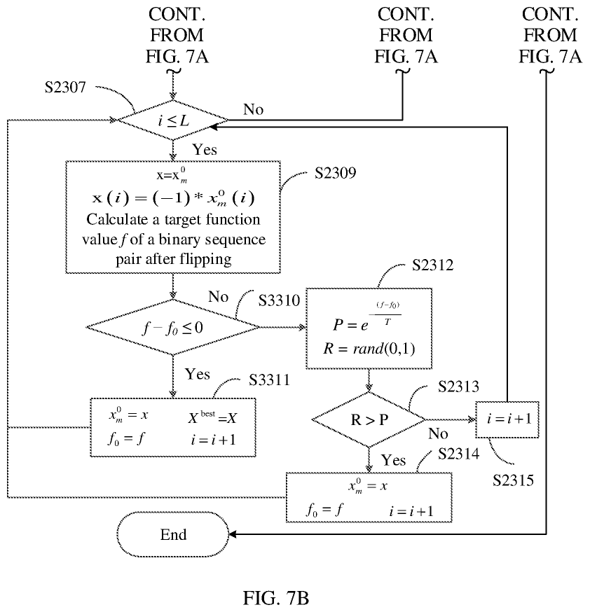

To further understand the method for generating a binary sequence pair provided in at least one embodiment, the following describes a process of the method for generating a binary sequence pair provided in at least one embodiment by using an example with reference to FIG. 6, and FIG. 7A and FIG. 7B.

FIG. 6 is a main flowchart of a method for generating a binary sequence pair according to a specific implementation. The method includes the following steps.
S210a and S210b: Receive an input initial parameter value, and complete initialization of each parameter, including:
enabling an initial binary sequence pair of an input binary sequence pair X to be X⁰, that is, X=X⁰; and enabling an initial value of an optimal binary sequence pair X^{best} to be X⁰, that is, X^{best}=X⁰, where a total quantity of sequences included in the initial binary sequence pair X⁰ (that is, a size of the binary sequence pair) is M, and a quantity (that is, a length) of elements included in each sequence of the binary sequence pair is L.

A preset minimum annealing temperature to be used in a simulated annealing algorithm is Tₘᵢₙ, and a preset annealing coefficient is α, where α>0, and a value of α is a value less than and close to 1, for example, 0.96, 0.95, or the like.
S220: Determine a value relationship between a current annealing temperature T and the preset minimum annealing temperature Tₘᵢₙ, in response to T≤Tₘᵢₙ, that is, in response to the current annealing temperature being less than the preset minimum annealing temperature (corresponding to the exit condition 1 in S440), output the optimal binary sequence pair, and end this process; otherwise perform step S230.
S230: Iteratively update the input binary sequence pair X for n times by using a coordinate descent algorithm, iteratively update the optimal binary sequence pair X^{best}, and calculate a target function value f of the binary sequence pair after each update. After the iteration in which the coordinate descent algorithm is used ends, the output binary sequence pair is used as an output binary sequence pair at the current annealing temperature T. This step is described in detail below.

For a specific method for calculating the target function value f of the binary sequence pair after each update, refer to the foregoing step S122.
S240: As described in step S210, update the annealing temperature based on T=α*T, where α is the preset annealing coefficient.
S250a to S250c: Determine whether a target function value f of an output binary sequence pair at a previous annealing temperature (that is, before the annealing temperature is updated) is in a stable state for t consecutive times in a process that is of the simulated annealing algorithm and in which a temperature continuously decreases for t times. In response to yes, an optimal binary sequence pair X^{best} formed at the end of the iterative update in which the coordinate descent algorithm is used at the current annealing temperature is used as an output binary sequence pair at the current annealing temperature, and is used as an input binary sequence pair at a next annealing temperature; and return to step S220. In response to no, a binary sequence pair formed at the end of the iterative update in which the coordinate descent algorithm is used at the current annealing temperature is used as an output binary sequence pair at the current annealing temperature, and is used as an input binary sequence pair at a next annealing temperature; and return to step S220.

FIG. 7A and FIG. 7B show a specific implementation of iteratively updating the binary sequence pair X for the n times by using the coordinate descent algorithm in the foregoing step S230, which includes the following steps.
S2301: Input the initialized binary sequence pair X⁰, including the total quantity M of sequences of the input binary sequence pair X⁰ and the quantity L of elements included in each sequence; preset a maximum quantity of iterations in the coordinate descent algorithm to Num, preset a variable n used to iteratively calculate the iterations, and initialize n=1; further set a variable m, corresponding to the total quantity M of sequences of the binary sequence pair X⁰, used to calculate the sequences, where m∈M; and set a variable i, corresponding to the quantity L of elements, used to iteratively calculate the elements, where i∈L.
S2302: Calculate the target function value f of the binary sequence pair X⁰, and use the target function value as an initial value f₀ of the target function value. For a specific calculation method of the target function value f, refer to the foregoing step S122.
S2303a and S2303b: Determine a value relationship between n and the maximum quantity Num of iterations, where in response to n≤Num, that is, a current quantity of iterations is less than or equal to the maximum quantity of iterations, set m=1 for the variable, that is, set an initial value 1 for the variable m (iteration calculation starts from a first sequence in the binary sequence pair), and perform step S2304; and in response to n>Num, a quantity of iterations in the coordinate descent algorithm is completed, and end a current process of the coordinate descent algorithm.
S2304: Determine a value relationship between m and M, where in response to m≤M, iterative calculation is not completed for all sequences in the current binary sequence pair, and perform step S2306; and in response to m>M, iterative calculation is completed for all sequences in the binary sequence pair, and perform step S2305.
S2305: Set n=n+1, and return to step S2303 to perform next iterative calculation in the coordinate descent algorithm.
S2306: Set i=1 for the variable, that is, set an initial value 1 for the variable i (flipping calculation starts from a first element of a sequence), and then perform step S2307.
S2307: Determine a value relationship between i and L, where in response to i≤L, flipping calculation is not completed for all elements of the sequence, and perform step S2309; and in response to i>L, flipping calculation is completed for all elements of the sequence, and perform step S2308.
S2308: Set m=m+1, and return to step S2304 to process a next sequence.
S2309: Use a sequence x as an m^{th} sequence in the binary sequence pair X⁰, that is, x=xₘ⁰. This step indicates that the m^{th} sequence is to be processed.

The sequence x is processed to flip an i^{th} element of the m^{th} sequence in the binary sequence pair X⁰, that is, x(i)=(−1)*xₘ⁰(i).

The sequence x is updated, that is, an original element at a same location is replaced with a flipped element x(i). The replaced element and an element at another location form the m^{th} new sequence, and the updated sequence x and another sequence form a new binary sequence pair, that is, a binary sequence pair after flipping. A target function value of the binary sequence pair after flipping is calculated, and perform step S2310. For a specific method for calculating the target function value, refer to the foregoing step S122.
S2310: Determine a value relationship between the target function value f of the binary sequence pair after flipping and the target function value f₀ of the binary sequence pair before flipping. The value relationship is obtained by comparing a difference between the two values with 0. In response to f−f₀≤0, the binary sequence pair after current flipping is accepted, and the binary sequence pair is used as a binary sequence pair input into a next iteration. In this case, perform S2311, otherwise, perform S2312.
S2311: Set xₘ⁰=x, X^{best}=X, f₀=f, and i=i+1 to indicate that the binary sequence pair after flipping generated through the current iteration is accepted. In other words, the sequence x obtained after flipping is used as the m^{th} sequence in the binary sequence pair X⁰, that is, the m^{th} sequence is updated to the sequence obtained after flipping. The flipped binary sequence pair obtained through the current iteration is used as the optimal binary sequence pair, the target function value that is corresponding to the current iteration and that is of the flipped binary sequence pair is used as an initial target function value in the next iteration, and an element in the sequence is moved to a next element for flipping calculation. Then, return to step S2307.
S2312: Calculate an acceptance probability P, where

$$P = {e}^{- \frac{( f - {f}_{0} )}{T}} ,$$

and generate a random number R, where R is a random number between [0,1]. P is an acceptance probability function value, f is the target function value of the binary sequence pair after flipping, f₀ is the target function value of the binary sequence pair before flipping, and T is a current annealing temperature.
S2313 to S2315: Determine a value relationship between R and P. In response to R>P, xₘ⁰=x, f₀=f, and i=i+1 are set to indicate that the binary sequence pair after flipping generated through the current iteration is accepted. In other words, the sequence x obtained after flipping is used as the m^{th} sequence in the binary sequence pair X⁰, that is, the m^{th} sequence is updated to the sequence obtained after flipping. The flipped binary sequence pair obtained through the current iteration is used as the optimal binary sequence pair, the target function value that is corresponding to the current iteration and that is of the flipped binary sequence pair is used as an initial target function value in the next iteration, and an element in the sequence is moved to a next element for flipping calculation. Then, return to step S2307.

In response to R≤P, only i=i+1 is set, the m^{th} sequence is not updated, the optimal binary sequence pair is not updated, a target function corresponding to the binary sequence pair after flipping is not updated, that is, the flipped binary sequence pair is not recorded, and only an initial binary sequence pair in the next iteration is used as the binary sequence pair before flipping. Return to step S2307.

After a sensing sequence used for target sensing is obtained, the following describes at least one embodiment in more detail by using an example in which ranging is performed by using the sensing sequence. In this embodiment, a value of M is merely an example, and is not limited to the following several values. M is any integer greater than 0. In this embodiment, an example in which a length of a binary sequence pair is 2048 bits is used. Based on the foregoing description, the length of the binary sequence pair further is of other values such as 256 bits, 512 bits, 1024 bits, and the like. In addition, as described in the foregoing embodiments, x and y are the binary sequence pair, \tilde{x} and \tilde{y} and are respectively the inverted complex conjugates of x and y.

In an embodiment, in response to the length of the binary sequence pair being 2048 bits and M=1,
in an actual process of sending the ranging sequence, a radar transmitting end sends the ranging sequence in a pulse string manner, and a sequence sent over a transmit antenna in a vertical polarization direction V is a ranging sequence S_{Vm11}, that is, the first row of the matrix A in the foregoing embodiment:

S_{Vm11}=[x,−\tilde{y},−\tilde{y},−x,−\tilde{y},−x,x,−\tilde{y}].

The foregoing 8 sequences are sent over the transmit antenna in the vertical polarization direction V, where one sequence is sent in each PRI. The following sequentially indicates sequences sent in every 0 to 7 pulse repetition intervals PRI:

s_{V,0}=xs_{V,1}=−\tilde{y}s_{V,2}=−\tilde{y}s_{V,3}=−xs_{V,4}=−\tilde{y}s_{V,5}=−xs_{V,6}=xs_{V,7}=−\tilde{y}.

A sequence sent over the transmit antenna in a horizontal polarization direction H is a ranging sequence S_{Hm42}, that is, the second row of the matrix A:

S_{Hm12}=[y,\tilde{x},\tilde{x},−y,\tilde{x},−y,y,\tilde{x}]

The foregoing 8 sequences are sent over the transmit antenna in the horizontal polarization direction H, where one sequence is sent in each PRI. The following sequentially indicates sequences sent in every 0 to 7 pulse repetition intervals PRI:

s_{H,0}=ys_{H,1}=\tilde{x}s_{H,2}=\tilde{x}s_{H,3}=−ys_{H,4}=\tilde{x}s_{H,5}=−ys_{H,6}=ys_{H,7}=−\tilde{x}.

Correspondingly, at a receiving end, filter banks are separately disposed at a receive antenna corresponding to the vertical polarization direction V and a receive antenna corresponding to the horizontal polarization direction H. The filter banks separately calculate ambiguity functions. For example, in response to each filter bank having two filters, the following is calculated for a sequence received by the receive antenna corresponding to the vertical polarization direction V.

A self-ambiguity function corresponding to a sent sequence S_{Vm41} is:

$$\begin{matrix}{g}_{VV} ( k , θ ) = {\sum }_{n = 0}^{7} {c}_{V , n} ( k ) {e}^{jn θ} \\ = {c}_{x} ( k ) + {c}_{y} ( k ) {e}^{j θ} + {c}_{y} ( k ) {e}^{j 2 θ} + {c}_{x} ( k ) {e}^{j 3 θ} + {c}_{y} ( k ) {e}^{j 4 θ} + \\ {c}_{x} ( k ) {e}^{j 5 θ} + {c}_{x} ( k ) {e}^{j 6 θ} + {c}_{y} ( k ) {e}^{j 7 θ}\end{matrix} .$$

A mutual ambiguity function corresponding to sent sequences S_{Vm41} and S_{Hm42} is:

$$\begin{matrix}{g}_{VH} ( k , θ ) = {\sum }_{n = 0}^{7} {c}_{VH , n} ( k ) {e}^{jn θ} \\ = {c}_{xy} ( k ) - {c}_{xy} ( k ) {e}^{j θ} - {c}_{xy} ( k ) {e}^{j 2 θ} + {c}_{xy} ( k ) {e}^{j 3 θ} - {c}_{xy} ( k ) {e}^{j 4 θ} + \\ {c}_{xy} ( k ) {e}^{j 5 θ} + {c}_{xy} ( k ) {e}^{j 6 θ} - {c}_{xy} ( k ) {e}^{j 7 θ}\end{matrix} .$$

Similarly, the following self-ambiguity and mutual ambiguity functions is calculated for a sequence received by the receive antenna corresponding to the horizontal polarization direction H:
g_{H,V}(k,θ) and g_{H,H}(k,θ)

k indicates a delay, θ indicates a Doppler shift, Cₓ(k) indicates an autocorrelation function of the sequence x, C_{y}(k) indicates an autocorrelation function of the sequence y, and C_{xy}(k) indicates a cross-correlation function of x and y.

Based on the foregoing description, after the calculation of the self-ambiguity function and the calculation of the mutual ambiguity function are performed, a value is further calculated based on a total output (k), the self-ambiguity function, and the mutual ambiguity function to obtain a PSM:

$$[ \begin{matrix}{h}_{VV} & {h}_{VH} \\ {h}_{HV} & {h}_{HH}\end{matrix} ] .$$

Therefore, after the PSM is calculated, ranging information and the like is further obtained based on the PSM.

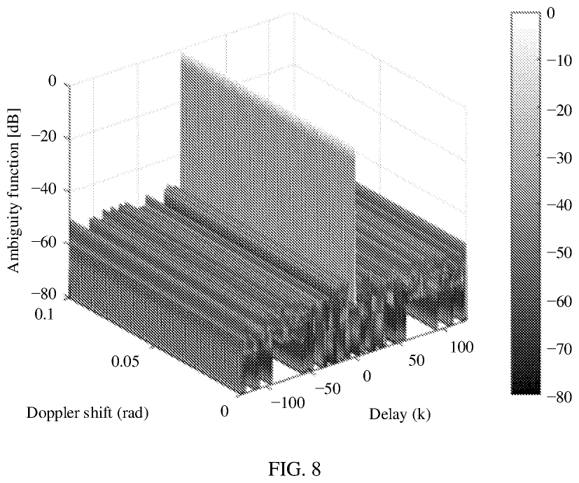

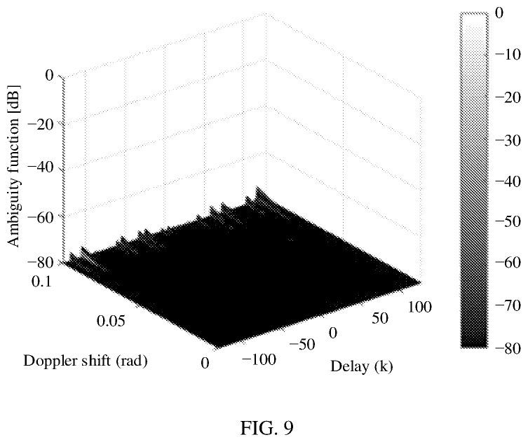

FIG. 8 and FIG. 9 respectively show a self-ambiguity function and a mutual ambiguity function of a sequence that is constructed based on a binary sequence pair whose length is 2048 bits and that is used for sensing. As shown in FIG. 8, a self-ambiguity function model of the sensing sequence shows that a main lobe (a location 0) of a sequence autocorrelation remains stable under any Doppler frequency offset. This indicates that the sensing sequence in at least one embodiment has high Doppler tolerance during target sensing. In addition, the autocorrelation of the sequence is close to zero in a local range (a location other than 0), a maximum side lobe of the self-ambiguity function in the local range is −49.32 dB, and a self-ambiguity side lobe is low. This indicates that at least one embodiment facilitates better implementation of target sensing. As shown in FIG. 9, a mutual ambiguity function value of the sequence in at least one embodiment reaches −73.79 dB in the local range. The mutual ambiguity function value is low, and mutual interference between sequences is small. This facilitates better target sensing.

In still another embodiment, in response to the length of the binary sequence pair being 2048 bits and M=2,
in an actual process of sending the ranging sequence, a radar transmitting end sends the ranging sequence in a pulse string manner, and a sequence sent over a transmit antenna in a vertical polarization direction V is a ranging sequence S_{Vm21}, that is, the first row of the matrix A2:

S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x].

The foregoing 16 sequences are sent over the transmit antenna in the vertical polarization direction V, where one sequence is sent in each PRI.

A sequence sent over the transmit antenna in a horizontal polarization direction H is a ranging sequence S_{Hm22}, that is, the second row of the matrix A2:

S_{Hm22}=[y,\tilde{x},\tilde{x},−y,\tilde{x},−y,y,\tilde{x},\tilde{x},−y,y,\tilde{x},y,\tilde{x},\tilde{x},−y].

The foregoing 16 sequences are sent over the transmit antenna in the horizontal polarization direction H, where one sequence is sent in each PRI.

At a radar receiving end, filter banks are separately disposed at a receive antenna corresponding to the vertical polarization direction V and a receive antenna corresponding to the horizontal polarization direction H. Ambiguity functions are separately calculated. For example, in response to each filter bank having two filters, the following is calculated for a sequence received by the receive antenna corresponding to the vertical polarization direction V.

A self-ambiguity function corresponding to a sent sequence S_{Vm21} is:

$$\begin{matrix}{g}_{VV} ( k , θ ) = {\sum }_{n = 0}^{15} {c}_{V , n} ( k ) {e}^{jn θ} \\ = {c}_{x} ( k ) + {c}_{y} ( k ) {e}^{j 2 θ} + {c}_{y} ( k ) {e}^{j 3 θ} + {c}_{x} ( k ) {e}^{j 4 θ} + {c}_{y} ( k ) {e}^{j 5 θ} + \\ {c}_{x} ( k ) {e}^{j 6 θ} + {c}_{x} ( k ) {e}^{j 7 θ} + {c}_{y} ( k ) {e}^{j 8 θ} + {c}_{y} ( k ) {e}^{j 9 θ} + {c}_{x} ( k ) {e}^{j 10 θ} + \\ {c}_{x} ( k ) {e}^{j 11 θ} + {c}_{y} ( k ) {e}^{j 12 θ} + {c}_{x} ( k ) {e}^{j 13 θ} + {c}_{y} ( k ) {e}^{j 14 θ} + \\ {c}_{y} ( k ) {e}^{j 15 θ} + {c}_{x} ( k ) {e}^{j 16 θ}\end{matrix} .$$

A mutual ambiguity function corresponding to sent sequences S_{Vm21} and S_{Hm22} is:

$$\begin{matrix}{g}_{VH} ( k , θ ) = {\sum }_{n = 0}^{15} {c}_{VH , n} ( k ) {e}^{jn θ} \\ = {c}_{xy} ( k ) - {c}_{xy} ( k ) {e}^{j 2 θ} - {c}_{xy} ( k ) {e}^{j 3 θ} + {c}_{xy} ( k ) {e}^{j 4 θ} - {c}_{xy} ( k ) {e}^{j 5 θ} + \\ {c}_{xy} ( k ) {e}^{j 6 θ} + {c}_{xy} ( k ) {e}^{j 7 θ} - {c}_{xy} ( k ) {e}^{j 8 θ} - {c}_{xy} ( k ) {e}^{j 90} + {c}_{xy} ( k ) {e}^{j 10 θ} + \\ {c}_{xy} ( k ) {e}^{j 11 θ} - {c}_{xy} ( k ) {e}^{j 12 θ} + {c}_{xy} ( k ) {e}^{j 13 θ} - {c}_{xy} ( k ) {e}^{j 14 θ} - \\ {c}_{xy} ( k ) {e}^{j 15 θ} + {c}_{xy} ( k ) {e}^{j 16 θ}\end{matrix} .$$

Similarly, self-ambiguity and mutual ambiguity functions is calculated for a sequence received by the receive antenna corresponding to the horizontal polarization direction H.

k indicates a delay, θ indicates a Doppler shift, Cₓ(k) indicates an autocorrelation function of the sequence x, C_{y}(k) indicates an autocorrelation function of the sequence y, and C_{xy}(k) indicates a cross-correlation function of x and y.

Based on the foregoing description, after the calculation of the self-ambiguity function and the calculation of the mutual ambiguity function are performed, a value is further calculated based on a total output (k), the self-ambiguity function, and the mutual ambiguity function to obtain a PSM:

$$[ \begin{matrix}{h}_{VV} & {h}_{VH} \\ {h}_{HV} & {h}_{HH}\end{matrix} ] .$$

Therefore, after the PSM is calculated, ranging information and the like is further obtained based on the PSM.

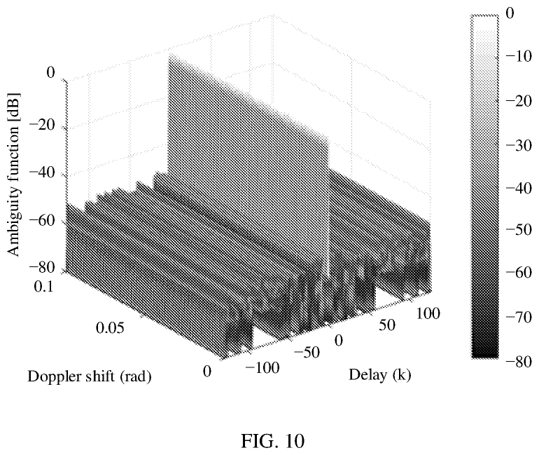

FIG. 10 and FIG. 11 respectively show a self-ambiguity function and a mutual ambiguity function of a sequence that is constructed based on a binary sequence pair whose length is 2048 bits and that is used for sensing. As shown in FIG. 10, a self-ambiguity function model of the sensing sequence shows that a main lobe (a location 0) of a sequence autocorrelation remains stable under any Doppler frequency offset. This indicates that the sensing sequence in at least one embodiment has high Doppler tolerance during target sensing. In addition, the autocorrelation of the sequence is close to zero in a local range (a location other than 0), a maximum side lobe of the self-ambiguity function in the local range is −49.32 dB, and a self-ambiguity side lobe is low. This indicates that at least one embodiment facilitates better implementation of target sensing. As shown in FIG. 11, a mutual ambiguity function value of the sequence in at least one embodiment reaches −80.57 dB in the local range. The mutual ambiguity function value is low, and mutual interference between sequences is small. This facilitates better target sensing.

In still another embodiment, in response to the length of the binary sequence pair being 2048 bits and M=3,
in an actual process of sending the ranging sequence, a radar transmitting end sends the ranging sequence in a pulse string manner, and a sequence sent over a transmit antenna in a vertical polarization direction V is a ranging sequence S_{Vm31}, that is, the first row of the matrix A3:

S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]

The foregoing 32 sequences are sent over the transmit antenna in the vertical polarization direction V, where one sequence is sent in each PRI.

A sequence sent over the transmit antenna in a horizontal polarization direction H is a ranging sequence S_{Hm32}, that is, the second row of the matrix A3:

S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

The foregoing 32 sequences are sent over the transmit antenna in the horizontal polarization direction H, where one sequence is sent in each PRI.

At a receiving end, filter banks are separately disposed at a receive antenna corresponding to the vertical polarization direction V and a receive antenna corresponding to the horizontal polarization direction H. Ambiguity functions are separately calculated. For example, in response to each filter bank having two filters, the following is calculated for a sequence received by the receive antenna corresponding to the vertical polarization direction V.

A self-ambiguity function corresponding to a sent sequence s_{V} is:

$${g}_{V V} ( k , θ ) = {\sum }_{n = 0}^{31} {c}_{V , n} ( k ) {e}^{j n θ} = {c}_{x} ( k ) + {c}_{y} ( k ) {e}^{j 2 θ} + {c}_{y} ( k ) {e}^{j 3 θ} + {c}_{x} ( k ) {e}^{j 4 θ} + {c}_{y} ( k ) {e}^{j 5 θ} + {c}_{x} ( k ) {e}^{j 6 θ} + {c}_{x} ( k ) {e}^{j 7 θ} + {c}_{y} ( k ) {e}^{j 8 θ} + {c}_{y} ( k ) {e}^{j 9 θ} + {c}_{x} ( k ) {e}^{j 10 θ} + {c}_{x} ( k ) {e}^{j 11 θ} + {c}_{y} ( k ) {e}^{j 12 θ} + {c}_{x} ( k ) {e}^{j 13 θ} + {c}_{y} ( k ) {e}^{j 14 θ} + {c}_{y} ( k ) {e}^{j 15 θ} + {c}_{x} ( k ) {e}^{j 16 θ} + {c}_{y} ( k ) {e}^{j 17 θ} + {c}_{x} ( k ) {e}^{j 18 θ} + {c}_{x} ( k ) {e}^{j 19 θ} + {c}_{y} ( k ) {e}^{j 20 θ} + {c}_{x} ( k ) {e}^{j 21 θ} + {c}_{y} ( k ) {e}^{j 22 θ} + {c}_{y} ( k ) {e}^{j 23 θ} + {c}_{x} ( k ) {e}^{j 24 θ} + {c}_{x} ( k ) {e}^{j 25 θ} + {c}_{y} ( k ) {e}^{j 26 θ} + {c}_{y} ( k ) {e}^{j 27 θ} + {c}_{x} ( k ) {e}^{j 28 θ} + {c}_{y} ( k ) {e}^{j 29 θ} + {c}_{x} ( k ) {e}^{j 30 θ} + {c}_{x} ( k ) {e}^{j 31 θ} + {c}_{y} ( k ) {e}^{j 32 θ} .$$

A mutual ambiguity function corresponding to sent sequences s_{V} and s_{H} is:

$${g}_{V H} ( k , θ ) = {\sum }_{n = 0}^{31} {c}_{VH , n} ( k ) {e}^{j n θ} = {c}_{x y} ( k ) - {c}_{xy} ( k ) {e}^{j 2 θ} - {c}_{x y} ( k ) {e}^{j 3 θ} + {c}_{xy} ( k ) {e}^{j 4 θ} - {c}_{xy} ( k ) {e}^{j 5 θ} + {c}_{xy} ( k ) {e}^{j 6 θ} + {c}_{x y} ( k ) {e}^{j 7 θ} - {c}_{xy} ( k ) {e}^{j 8 θ} - {c}_{x y} ( k ) {e}^{j 9 θ} + {c}_{xy} ( k ) {e}^{j 10 θ} + {c}_{x y} ( k ) {e}^{j 11 θ} - {c}_{xy} ( k ) {e}^{j 12 θ} + {c}_{x y} ( k ) {e}^{j 13 θ} - {c}_{xy} ( k ) {e}^{j 14 θ} - {c}_{x y} ( k ) {e}^{j 15 θ} + {c}_{x y} ( k ) {e}^{j 16 θ} - {c}_{xy} ( k ) {e}^{j 17 θ} + {c}_{x y} ( k ) {e}^{j 18 θ} + {c}_{x y} ( k ) {e}^{j 19 θ} - {c}_{xy} ( k ) {e}^{j 20 θ} + {c}_{x y} ( k ) {e}^{j 21 θ} - {c}_{x y} ( k ) {e}^{j 22 θ} - {c}_{xy} ( k ) {e}^{j 23 θ} + {c}_{x y} ( k ) {e}^{j 24 θ} + {c}_{x y} ( k ) {e}^{j 25 θ} - {c}_{x y} ( k ) {e}^{j 26 θ} - {c}_{xy} ( k ) {e}^{j 27 θ} + {c}_{x y} ( k ) {e}^{j 28 θ} - {c}_{x y} ( k ) {e}^{j 29 θ} + {c}_{x y} ( k ) {e}^{j 30 θ} + {c}_{xy} ( k ) {e}^{j 31 θ} - {c}_{x y} ( k ) {e}^{j 32 θ} .$$

Similarly, self-ambiguity and mutual ambiguity functions is calculated for a sequence received by the receive antenna corresponding to the horizontal polarization direction H. k indicates a delay, θ indicates a Doppler shift, Cₓ(k) indicates an autocorrelation function of the sequence x, C_{y}(k) indicates an autocorrelation function of the sequence y, and C_{xy}(k) indicates a cross-correlation function of x and y. Based on the foregoing description, after the calculation of the self-ambiguity function and the calculation of the mutual ambiguity function are performed, a value is further calculated based on a total output (k), the self-ambiguity function, and the mutual ambiguity function to obtain a PSM:

$$[ \begin{matrix}{h}_{VV} & {h}_{VH} \\ {h}_{HV} & {h}_{HH}\end{matrix} ] .$$

Therefore, after the PSM is calculated, ranging information and the like is further obtained based on the PSM.

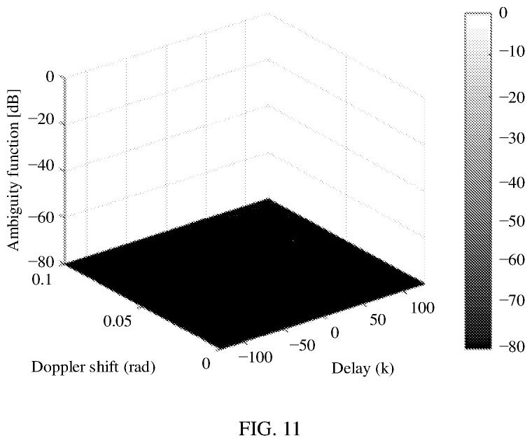

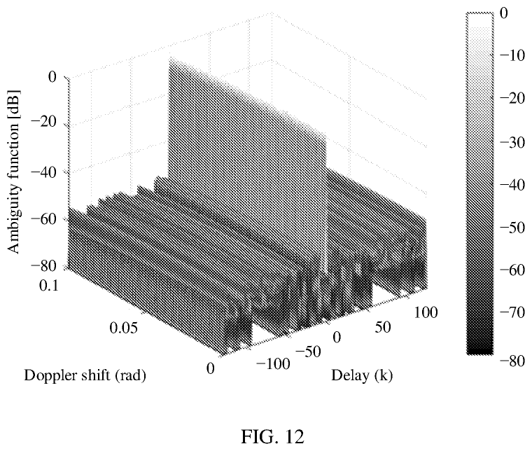

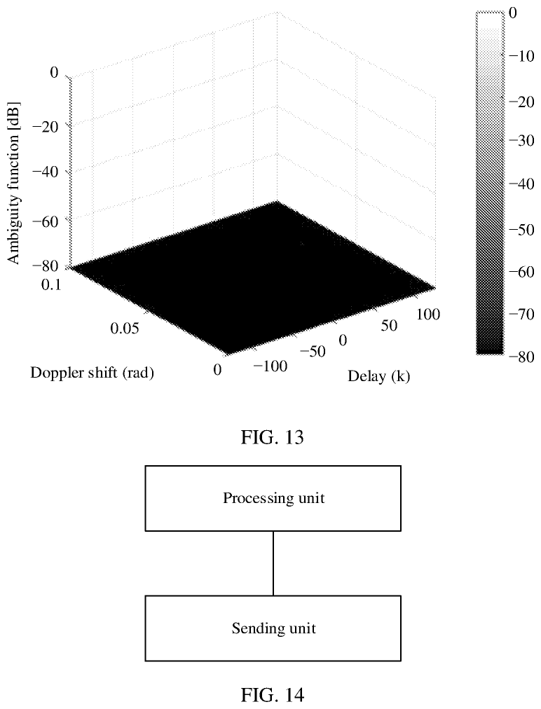

FIG. 12 and FIG. 13 respectively show a self-ambiguity function and a mutual ambiguity function of a sequence that is constructed based on a binary sequence pair whose length is 2048 bits and that is used for sensing. As shown in FIG. 12, a self-ambiguity function model of the sensing sequence shows that a main lobe (a location 0) of a sequence autocorrelation remains stable under any Doppler frequency offset. This indicates that the sensing sequence in at least one embodiment has high Doppler tolerance during target sensing. In addition, the autocorrelation of the sequence is close to zero in a local range (a location other than 0), a maximum side lobe of the self-ambiguity function in the local range is −49.32 dB, and a self-ambiguity side lobe is low. This indicates that at least one embodiment facilitates better implementation of target sensing. As shown in FIG. 13, a mutual ambiguity function value of the sequence in at least one embodiment reaches −82.28 dB in the local range. The mutual ambiguity function value is low, and mutual interference between sequences is small. This facilitates better target sensing.

Corresponding to the foregoing method embodiments, the following relates to apparatus embodiments. For beneficial effects or resolved technical problems of the apparatuses, refer to description in the methods corresponding to apparatuses, or refer to description in the content of summary. Details are not described herein again.

As shown in FIG. 14, at least one embodiment at least one embodiment a schematic diagram of a structure of a data transmission apparatus applied to a transmitting end. The apparatus includes:
a processing unit, configured to generate a physical layer protocol data unit PPDU, where the PPDU includes a training field, and the training field includes a sequence used for target sensing; and
a sending unit, configured to send the PPDU.

The data transmission apparatus applied to the transmitting end provided in this embodiment is the transmitting end in the foregoing method, and the data transmission apparatus has any function of the transmitting end in the foregoing method. For specific details, refer to the foregoing method. Details are not described herein again.

In this embodiment, the sequence that is used for target sensing and that is included in the training field is obtained based on a binary sequence pair, an Alamouti matrix, and a Prouhet-Thue-Morse PTM (Prouhet-Thue-Morse, PTM) sequence, where the Alamouti matrix includes:

$$A 0 = [ \begin{matrix}x , - \tilde{y} \\ y , \tilde{x}\end{matrix} ] and A 1 = [ \begin{matrix}- \tilde{y} , - x \\ \tilde{x} , - y\end{matrix} ] .$$

In response to x and y being the binary sequence pair, \tilde{x} and \tilde{y} are respectively inverted complex conjugates of x and y, A0 corresponds to 0 in the PTM sequence, and A1 corresponds to 1 in the PTM sequence. To be specific, in response to an element value in the PTM sequence being 0, the element value in the PTM sequence corresponds to A0 in the Alamouti matrix; and in response to an element value in the PTM sequence being 1, the element value in the PTM sequence corresponds to A1 in the Alamouti matrix. The transmitting end obtains the first matrix according to the foregoing correspondence between a PTM sequence and an Alamouti matrix. A first row of the first matrix forms a sequence in a V polarization direction, and a second row of the matrix forms a sequence in an H polarization direction. In other words, the first row and the second row of the first matrix form the sequence used for target sensing in at least one embodiment. Further, the PTM sequence is {aₙ}ₙ₌₀ⁿ⁻¹, and its recursion is defined as a₀=0, a₂ₖ=aₖ, and a₂k+1=1−aₖ, where k>0, a length of the PTM sequence is 2^{M+1}, and M is an integer greater than 0. M has different values. Different values of M correspond to sequences of different lengths used for sensing. A larger value of M indicates a longer correspondingly generated sequence used for target sensing, less interference between sequences in response to the sequence being used for sensing, and better sensing performance. For example, the following provides several different M values to correspondingly obtain sequences of different lengths used for sensing. A value of M is merely an example, and is not limited to the following several values. Based on the foregoing description, M is any integer value greater than 0. In addition, based on the method provided in at least one embodiment, sequences of different lengths used for target sensing is obtained for different values of M.

In an embodiment, in response to M=1, sequences used for target sensing is S_{Vm11} and S_{Hm12}. Specifically, the sequences used for target sensing are:

S_{Vm11}=[x,−\tilde{y},−\tilde{y},−x,−\tilde{y},−x,x,−\tilde{y}]; and

S_{Hm12}=[y,\tilde{x},\tilde{x},−y,\tilde{x},−y,y,\tilde{x}].

Specifically, in response to M=1, a length of the PTM sequence is 4, a value of the PTM sequence is 0110, and the first matrix A=[A0 A1 A1 A0] obtained according to the correspondence between an Alamouti matrix and a PTM sequence is specifically:

$$A = [ \begin{matrix}x , - \tilde{y} , - \tilde{y} , - x , - \tilde{y} , - x , x , - \tilde{y} \\ y , \tilde{x} , \tilde{x} , - y , \tilde{x} , - y , y , \tilde{x}\end{matrix} ] .$$

A first row of the first matrix A corresponds to S_{Vm11} of the target sensing sequences, and a second row of the first matrix A corresponds to S_{Hm12} of the target sensing sequences.

In still another embodiment, in response to M=2, sequences used for target sensing is S_{Vm21} and S_{Hm22}. Specifically, the sequences used for target sensing are S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and S_{Hm22}=[y,\tilde{x},\tilde{x},−y,\tilde{x},−y,y,\tilde{x},\tilde{x},−y,y,\tilde{x},y,\tilde{x},\tilde{x},−y].

Specifically, in response to M=2, a length of the PTM sequence is 16, a value of the PTM sequence is 01101001, and the PTM sequence 01101001 corresponds to eight Alamouti matrices A0 A1 A1 A0 A1 A0 A0 A1. The eight Alamouti matrices form a first matrix A2=[A0 A1 A1 A0 A1 A0 A0 A1]. Specifically,

$$A 2 = [ \begin{matrix}x , - \tilde{y} , - \tilde{y} , - x , - \tilde{y} , - x , x , - \tilde{y} , - \tilde{y} , - x , x , - \tilde{y} , x , - \tilde{y} , - \tilde{y} , - x \\ y , \tilde{x} , \tilde{x} , - y , \tilde{x} , - y , y , \tilde{x} , \tilde{x} , - y , y , \tilde{x} , y , \tilde{x} , \tilde{x} , - y\end{matrix} ] .$$

A first row of the first matrix A2 corresponds to S_{Vm11} of the target sensing sequences, and a second row of the first matrix A2 corresponds to S_{Hm12} of the target sensing sequences.

In still another embodiment, in response to M=3, sequences used for target sensing is S_{Vm31} and S_{Hm32}. In this case, the sequences used for target sensing is:

S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and

S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

Specifically, in response to M=3, a length of the PTM sequence is 16, a value of the PTM sequence is 0110100110010110, and the PTM sequence 0110100110010110 corresponds to 16 Alamouti matrices A0 A1 A1 A0 A1 A0 A0 A1 A1 A0 A0 A1 A0 A1 A1 A0. The 16 Alamouti matrices form a first matrix A3=[A0 A1 A1 A0 A1 A0 A0 A1 A1 A0 A0 A1 A0 A1 A1 A0]. Specifically,

$$A 3 = [ \begin{matrix}\begin{matrix}x , - \tilde{y} , - \tilde{y} , - x , - \tilde{y} , - x , x , - \tilde{y} , - \tilde{y} , - x , x , - \tilde{y} , x , - \tilde{y} , - \tilde{y} , - x , \\ - \tilde{y} , - x , x , - \tilde{y} , x , - \tilde{y} , - \tilde{y} , - x , x , - \tilde{y} , - \tilde{y} , - x , - \tilde{y} , - x , x , - \tilde{y}\end{matrix} \\ \begin{matrix}y , \tilde{x} , \tilde{x} , - y , \tilde{x} , - y , y , \tilde{x} , \tilde{x} , - y , y , \tilde{x} , y , \tilde{x} , \tilde{x} , - y , \\ \tilde{x} , - y , y , \tilde{x} , y , \tilde{x} , \tilde{x} , - y , y , \tilde{x} , \tilde{x} , - y , \tilde{x} , - y , y , \tilde{x}\end{matrix}\end{matrix} ] .$$

A first row of the first matrix A3 corresponds to S_{Vm11} of the target sensing sequences, and a second row of the first matrix A3 corresponds to S_{Hm12} of the target sensing sequences.

Based on the foregoing embodiment, sequences of different lengths used for target sensing is obtained based on the binary sequence pair, the Alamouti matrix, and the PTM sequence, and are applicable to different target sensing scenarios. In addition, the sequence used for sensing has high Doppler tolerance.

Further, a sequence length of the binary sequence pair used to generate the sequence used for sensing includes any one of the following: 256 bits, 512 bits, 1024 bits, and 2048 bits.

In an embodiment, the sequence length of the binary sequence pair is the 256 bits, and sequences corresponding to the binary sequence pair are: Sn2561 and Sn2562. That is, in the binary sequence pair, x corresponds to Sn2561, and y corresponds to Sn2562. For specific forms of Sn2561 and Sn2562, refer to the foregoing embodiments. Details are not described herein.

In an embodiment, the sequence length of the binary sequence pair is the 512 bits, and sequences corresponding to the binary sequence pair are: Sn5121 and Sn5122. That is, in the binary sequence pair, x corresponds to Sn5121, and y corresponds to Sn5122. For specific forms of Sn5121 and Sn5122, refer to the foregoing description of embodiments. Details are not described herein.

In an embodiment, the sequence length of the binary sequence pair is 1024, and sequences corresponding to the binary sequence pair are: Sn10241 and Sn10242. That is, in the binary sequence pair, x corresponds to Sn10241, and y corresponds to Sn10242. For specific forms of Sn10241 and Sn10242, refer to the foregoing description of embodiments. Details are not described herein.

In an embodiment, the sequence length of the binary sequence pair is 2048, and sequences corresponding to the binary sequence pair are: Sn20481 and Sn20482. That is, in the binary sequence pair, x corresponds to Sn20481, and y corresponds to Sn20482. For specific forms of Sn20481 and Sn20482, refer to the foregoing description of embodiments. Details are not described herein.

It is understood that, based on the foregoing embodiment, the binary sequence pair is used as a base sequence used for generating a sensing sequence, and a design principle of the binary sequence pair is that a local area has a low autocorrelation and a low cross-correlation. The low autocorrelation and the low cross-correlation mean that a sum of autocorrelations of the binary sequence pair in the local area is close to zero at a location other than 0, and that a cross-correlation in the area is also close to zero. The sum of the autocorrelations means that autocorrelation is separately performed on two sequences of the binary sequence pair, and then summation is performed. A location of 0 is a location at which the two sequences are completely aligned. The sensing sequence generated based on the binary sequence pair with the low autocorrelation and the low cross-correlation has high Doppler tolerance and good target sensing performance. Specifically, in response to the sensing sequence being used for sensing, a self-ambiguity function model of the sensing sequence shows that a main lobe (the location 0) of the sequence autocorrelation remains stable under any Doppler frequency offset. This indicates that the sensing sequence in at least one embodiment has high Doppler tolerance during target sensing. In addition, the self-ambiguity function model of the sensing sequence shows that the sequence autocorrelation is close to zero in a local range (a location other than 0) under any Doppler offset. This feature facilitates better implementation of target sensing. A mutual ambiguity function model shows that a mutual ambiguity function value is low, which indicates that mutual interference between sensing sequences is small. This indicates better target sensing. In addition, for the “local area” mentioned above, in response to an scope of an actual application scenario in the field of target sensing technologies and a speed of a single-carrier physical layer in an existing high frequency standard being 1.76 Gbps are considered, a range of the local area in the foregoing design criterion is set to ±128. The local area corresponds to ±21.82 meters in an actual scenario, and in a case of self-receiving and self-sending, the local area corresponds to ±10.91 meters in the actual scenario. A value of the range of the local area meets an application scenario in an existing high frequency related standard. The foregoing “±128 ” indicates that in response to a binary sequence pair in the range of the area being generated, one sequence remains unchanged, and the other sequence moves 128 (−128) to the left and 128 (+128) to the right.

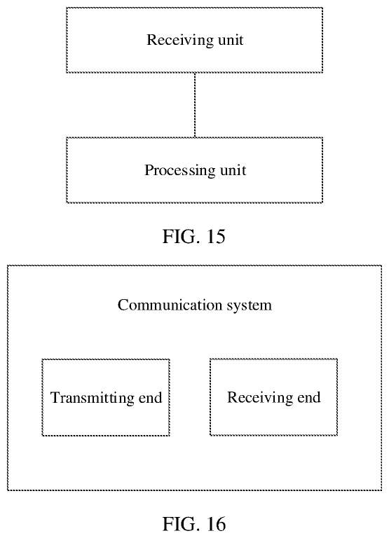

As shown in FIG. 15, at least one embodiment at least one embodiment a schematic diagram of a structure of a data transmission apparatus applied to a receiving end. The apparatus includes:
a receiving unit, configured to receive a physical layer protocol data unit PPDU, where the PPDU includes a training field, and the training field includes a sequence used for target sensing; and
a processing unit, configured to perform target sensing based on the sequence used for target sensing.

The data transmission apparatus applied to the receiving end provided in this embodiment is the receiving end in the foregoing method, and the data transmission apparatus has any function of the receiving end in the foregoing method. For specific details, refer to the foregoing method. Details are not described herein again.

In this embodiment, the sequence that is used for target sensing and that is included in the training field is obtained based on a binary sequence pair, an Alamouti matrix, and a Prouhet-Thue-Morse PTM (Prouhet-Thue-Morse, PTM) sequence, where the Alamouti matrix includes:

$$A 0 = [ \begin{matrix}x , - \tilde{y} \\ y , \tilde{x}\end{matrix} ] and A 1 = [ \begin{matrix}- \tilde{y} , - x \\ \tilde{x} , - y\end{matrix} ] .$$

In response to x and y being the binary sequence pair, \tilde{x} and \tilde{y} are respectively inverted complex conjugates of x and y, A0 corresponds to 0 in the PTM sequence, and A1 corresponds to 1 in the PTM sequence. To be specific, in response to an element value in the PTM sequence being 0, the element value in the PTM sequence corresponds to A0 in the Alamouti matrix; and in response to an element value in the PTM sequence being 1, the element value in the PTM sequence corresponds to A1 in the Alamouti matrix. The transmitting end obtains the first matrix according to the foregoing correspondence between a PTM sequence and an Alamouti matrix. A first row of the first matrix forms a sequence in a V polarization direction, and a second row of the matrix forms a sequence in an H polarization direction. In other words, the first row and the second row of the first matrix form the sequence used for target sensing in at least one embodiment. Further, the PTM sequence is {aₙ}ₙ₌₀^{N-1}, and its recursion is defined as a₀=0, a₂ₖ=aₖ, and a₂ₖ₊₁=1−aₖ, where k>0, a length of the PTM sequence is 2^{M+1}, and M is an integer greater than 0. M has different values. Different values of M correspond to sequences of different lengths used for sensing. A larger value of M indicates a longer correspondingly generated sequence used for target sensing, less interference between sequences in response to the sequence is used for sensing, and better sensing performance. For example, the following provides several different M values to correspondingly obtain sequences of different lengths used for sensing. A value of M is merely an example, and is not limited to the following several values. Based on the foregoing description, M is any integer value greater than 0. In addition, based on the method provided in at least one embodiment, sequences of different lengths used for target sensing is obtained for different values of M.

In an embodiment, in response to M=1, sequences used for target sensing is S_{Vm11} and S_{Hm12}. Specifically, the sequences used for target sensing are:

S_{Vm11}=[x,−\tilde{y},−\tilde{y},−x,−\tilde{y},−x,x,−\tilde{y}]; and

S_{Hm12}=[y,\tilde{x},\tilde{x},−y,\tilde{x},−y,y,\tilde{x}].

Specifically, in response to M=1, a length of the PTM sequence is 4, a value of the PTM sequence is 0110, and the first matrix A=[A0 A1 A1 A0] obtained according to the correspondence between an Alamouti matrix and a PTM sequence is specifically:

$$A = [ \begin{matrix}x , - \tilde{y} , - \tilde{y} , - x , - \tilde{y} , - x , x , - \tilde{y} \\ y , \tilde{x} , \tilde{x} , - y , \tilde{x} , - y , y , \tilde{x}\end{matrix} ] .$$

A first row of the first matrix A corresponds to S_{Vm11} of the target sensing sequences, and a second row of the first matrix A corresponds to S_{Hm12} of the target sensing sequences.

In still another embodiment, in response to M=2, sequences used for target sensing is S_{Vm21} and S_{Hm22}. Specifically, the sequences used for target sensing are S_{Vm21}=S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and S_{Hm22}=[y,\tilde{x},\tilde{x},−y,\tilde{x},−y,y,\tilde{x},\tilde{x},−y,y,\tilde{x},y,\tilde{x},\tilde{x},−y].

Specifically, in response to M=2, a length of the PTM sequence is 16, a value of the PTM sequence is 01101001, and the PTM sequence 01101001 corresponds to eight Alamouti matrices A0 A1 A1 A0 A1 A0 A0 A1. The eight Alamouti matrices form a first matrix A2=[A0 A1 A1 A0 A1 A0 A0 A1]. Specifically,

$$A 2 = [ \begin{matrix}x , - \tilde{y} , - \tilde{y} , - x , - \tilde{y} , - x , x , - \tilde{y} , - \tilde{y} , - x , x , - \tilde{y} , x , - \tilde{y} , - \tilde{y} , - x \\ y , \tilde{x} , \tilde{x} , - y , \tilde{x} , - y , y , \tilde{x} , \tilde{x} , - y , y , \tilde{x} , y , \tilde{x} , \tilde{x} , - y\end{matrix} ] .$$

A first row of the first matrix A2 corresponds to S_{Vm11} of the target sensing sequences, and a second row of the first matrix A2 corresponds to S_{Hm12} of the target sensing sequences.

In still another embodiment, in response to M=3, sequences used for target sensing is S_{Vm31} and S_{Hm32}. In this case, the sequence used for target sensing is:

S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and

S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

Specifically, in response to M=3, a length of the PTM sequence is 16, a value of the PTM sequence is 0110100110010110, and the PTM sequence 0110100110010110 corresponds to 16 Alamouti matrices A0 A1 A1 A0 A1 A0 A0 A1 A1 A0 A0 A1 A0 A1 A1 A0. The 16 Alamouti matrices form a first matrix A3=[A0 A1 A1 A0 A1 A0 A0 A1 A1 A0 A0 A1 A0 A1 A1 A0]. Specifically,

$$A 3 = [ \begin{matrix}\begin{matrix}x , - \tilde{y} , - \tilde{y} , - x , - \tilde{y} , - x , x , - \tilde{y} , - \tilde{y} , - x , x , - \tilde{y} , x , - \tilde{y} , - \tilde{y} , - x , \\ - \tilde{y} , - x , x , - \tilde{y} , x , - \tilde{y} , - \tilde{y} , - x , x , - \tilde{y} , - \tilde{y} , - x , - \tilde{y} , - x , x , - \tilde{y}\end{matrix} \\ \begin{matrix}y , \tilde{x} , \tilde{x} , - y , \tilde{x} , - y , y , \tilde{x} , \tilde{x} , - y , y , \tilde{x} , y , \tilde{x} , \tilde{x} , - y , \\ \tilde{x} , - y , y , \tilde{x} , y , \tilde{x} , \tilde{x} , - y , y , \tilde{x} , \tilde{x} , - y , \tilde{x} , - y , y , \tilde{x}\end{matrix}\end{matrix} ] .$$

A first row of the first matrix A3 corresponds to S_{Vm11} of the target sensing sequences, and a second row of the first matrix A3 corresponds to S_{Hm12} of the target sensing sequences.

Based on the foregoing embodiment, sequences of different lengths used for target sensing is obtained based on the binary sequence pair, the Alamouti matrix, and the PTM sequence, and are applicable to different target sensing scenarios. In addition, the sequence used for sensing has high Doppler tolerance.

Further, a sequence length of the binary sequence pair used to generate the sequence used for sensing includes any one of the following: 256 bits, 512 bits, 1024 bits, and 2048 bits.

In an embodiment, the sequence length of the binary sequence pair is the 256 bits, and sequences corresponding to the binary sequence pair are: Sn2561 and Sn2562. That is, in the binary sequence pair, x corresponds to Sn2561, and y corresponds to Sn2562. For specific forms of Sn2561 and Sn2562, refer to the foregoing description of embodiments. Details are not described herein.

In an embodiment, the sequence length of the binary sequence pair is the 512 bits, and sequences corresponding to the binary sequence pair are: Sn5121 and Sn5122. That is, in the binary sequence pair, x corresponds to Sn5121, and y corresponds to Sn5122. For specific forms of Sn5121 and Sn5122, refer to the foregoing description of embodiments. Details are not described herein.

In an embodiment, the sequence length of the binary sequence pair is 1024, and sequences corresponding to the binary sequence pair are: Sn10241 and Sn10242. That is, in the binary sequence pair, x corresponds to Sn10241, and y corresponds to Sn10242. For specific forms of Sn10241 and Sn10242, refer to the foregoing description of embodiments. Details are not described herein.

In an embodiment, the sequence length of the binary sequence pair is 2048, and sequences corresponding to the binary sequence pair are: Sn20481 and Sn20482. That is, in the binary sequence pair, x corresponds to Sn20481, and y corresponds to Sn20482. For specific forms of Sn20481 and Sn20482, refer to the foregoing description of embodiments. Details are not described herein.

Specifically, for beneficial effects of the foregoing embodiments, refer to description of the method. Details are not described herein again.

The foregoing describes the data transmission apparatus applied to the transmitting end and the data transmission apparatus applied to the receiving end in at least one embodiment. The following describes product forms of the data transmission apparatus applied to the transmitting end and the data transmission apparatus applied to the receiving end. Any product in any form that has the feature of the data transmission apparatus applied to the transmitting end in FIG. 14 and any product in any form that has the feature of the data transmission apparatus applied to the receiving end in FIG. 15 shall fall within the protection scope of at least one embodiment. The following description is merely an example, and a product form of the data transmission apparatus applied to the transmitting end and a product form of the data transmission apparatus applied to the receiving end in at least one embodiment are not limited thereto.

In a product form, the data transmission apparatus applied to the transmitting end and the data transmission apparatus applied to the receiving end in at least one embodiment is implemented by using a general bus architecture.

The data transmission apparatus applied to the transmitting end includes a processor and a transceiver that internally connects to and communicates with the processor. The processor is configured to generate a physical layer protocol data unit PPDU, where the PPDU includes a training field, and the training field includes a sequence used for target sensing. The transceiver is configured to send the physical layer protocol data unit PPDU.

Optionally, the data transmission apparatus applied to the transmitting end further includes a memory, and the memory is configured to store instructions executed by the processor.

Optionally, the memory is located inside the apparatus, or is located outside the apparatus.

The data transmission apparatus applied to the receiving end includes a processor and a transceiver that internally connects to and communicates with the processor. The transceiver is configured to receive a physical layer protocol data unit PPDU, where the PPDU includes a training field, and the training field includes a sequence used for target sensing. The processor is configured to perform target sensing based on the sequence used for target sensing.

Optionally, the data transmission apparatus applied to the receiving end further includes a memory, and the memory is configured to store instructions executed by the processor.

Optionally, the memory is located inside the apparatus, or is located outside the apparatus.

In a product form, the data transmission apparatus applied to the transmitting end and the data transmission apparatus applied to the receiving end in at least one embodiment is implemented by a general-purpose processor.

The data transmission apparatus applied to the transmitting end includes a processing circuit and an output interface that internally connects to and communicates with the processing circuit. The processing circuit is configured to generate a physical layer protocol data unit PPDU, where the PPDU includes a training field, and the training field includes a sequence used for target sensing. The output interface is configured to output the PPDU. Optionally, the general-purpose processor further includes a storage medium, where the storage medium is configured to store instructions executed by the processing circuit.

The data transmission apparatus applied to the receiving end includes a processing circuit and an input interface that internally connects to and communicates with the processing circuit. The input interface is configured to input a physical layer protocol data unit PPDU, where the PPDU includes a training field, and the training field includes a sequence used for target sensing. The processing circuit is configured to perform target sensing based on the sequence used for target sensing. Optionally, the general-purpose processor further includes a storage medium, where the storage medium is configured to store instructions executed by the processing circuit.

In a product form, the data transmission apparatus applied to the transmitting end and the data transmission apparatus applied to the receiving end in at least one embodiment is further implemented by using one or more FPGAs (field programmable gate arrays), a PLD (programmable logic device), a controller, a state machine, gate logic, a discrete hardware component, any other suitable circuit, or any combination of circuits that perform various functions described in at least one embodiment.

It should be understood that the data transmission apparatus applied to the transmitting end and the data transmission apparatus applied to the receiving end in the foregoing various product forms separately have any function of the transmitting end and the receiving end in the foregoing method embodiments and achieve corresponding beneficial effects. Details are not described herein again.

According to another aspect, at least one embodiment further provides a computer-readable storage medium, configured to store a computer program, where the computer program includes instructions used to perform the data transmission method in any one of the foregoing method embodiments.

According to another aspect, at least one embodiment further provides a computer program product, where the computer program product includes instructions used to perform the data transmission method in any one of the foregoing method embodiments.

According to another aspect, as shown in FIG. 16, at least one embodiment further provides a communication system, including the foregoing transmitting end and the foregoing receiving end. The transmitting end generates and sends a PPDU, where the PPDU includes a training field, and the training field includes a sequence used for target sensing. The receiving end is configured to receive a PPDU and perform target sensing accordingly, where the PPDU includes a training field, and the training field includes a sequence used for target sensing. The sequence is the sequence described in any one of the foregoing embodiments.

It should be understood that, the term “and/or” describes only an association relationship between associated objects, and indicates that three relationships exist. For example, A and/or B indicate the following three cases: Only A exists, both A and B exist, and only B exists. In addition, the character “/” generally indicates an “or” relationship between associated objects.

A person of ordinary skill in the art is aware that, in combination with the examples described in embodiments disclosed herein, method steps and units is implemented by electronic hardware, computer software, or a combination thereof. To clearly describe the interchangeability between hardware and software, the foregoing description has generally described steps and compositions of each embodiment according to functions. Whether the functions are performed by hardware or software depends on particular applications and design constraint conditions of the technical solutions. A person of ordinary skill in the art uses different methods to implement the described functions for each particular embodiment, but the implementation does not go beyond the scope of embodiments described herein.

A person skilled in the art understands that, for the purpose of convenient and brief description, for a detailed working process of the foregoing described system, apparatus, and unit, refer to a corresponding process in the foregoing method embodiment. Details are not described herein again.

In the several embodiments described herein, the disclosed systems, apparatuses, and methods is implemented in other manners. For example, the described apparatus embodiments are merely examples. For example, division into units is merely logical function division and is other division in an actual implementation. For example, a plurality of units or components is combined or integrated into another system, or some features is ignored or not performed. In addition, the displayed or discussed mutual couplings or direct couplings or communication connections is implemented through some interfaces. The indirect couplings or communication connections between the apparatuses or units is implemented in electrical, mechanical, or other forms.

The units described as separate parts may or may not be physically separate, and parts displayed as units may or may not be physical units, is located in one position, or is distributed on a plurality of network units. Some or all of the units are selected based on an actual requirement to achieve the objectives of the solutions of embodiments.

In addition, functional units in at least one embodiment is integrated into one processing unit, or each of the units exist alone physically, or two or more units is integrated into one unit. The integrated unit is implemented in a form of hardware, or is implemented in a form of a software function unit.

In response to the integrated unit being implemented in the form of the software functional unit and is sold or used as an independent product, the integrated unit is stored in a computer-readable storage medium. Based on such an understanding, the technical solutions of at least one embodiment essentially, or the part contributing to the conventional technology, all or some of the technical solutions is implemented in a form of a software product. The computer software product is stored in a storage medium, and includes several instructions for instructing a computer device (which is a personal computer, a server, or a network device) or a processor to perform all or some of the steps of the methods described in at least one embodiment. The foregoing storage medium includes: any medium that stores program code, such as a USB flash drive, a removable hard disk, a read-only memory (read-only memory, ROM), a random access memory (random access memory, RAM), a magnetic disk, or an optical disc.

The foregoing description is merely a specific embodiment described herein, but is not intended to limit the protection scope of embodiments described herein. Any modification or replacement readily figured out by a person skilled in the art within the technical scope disclosed in at least one embodiment shall fall within the protection scope of at least one embodiment. Therefore, the protection scope of embodiments described herein shall be subject to the protection scope of the claims.

1. An apparatus, comprising:
a memory, storing computer instructions; and
a processor, configured to execute the computer instructions to cause the apparatus to:
generate a physical layer protocol data unit (PPDU), wherein the PPDU comprises a training field, and the training field comprises a sequence for target sensing; and
send the PPDU.

2. The apparatus according to claim 1, wherein the sequence for target sensing is obtained based on a binary sequence pair, an Alamouti matrix, and a Prouhet-Thue-Morse PTM sequence, wherein the Alamouti matrix comprises:
$$A 0 = [ \begin{matrix}x , - \tilde{y} \\ y , \tilde{x}\end{matrix} ] and A 1 = [ \begin{matrix}- \tilde{y} , - x \\ \tilde{x} , - y\end{matrix} ] ,$$
wherein
in response to x and y being the binary sequence pair, \tilde{x} and \tilde{y} are respectively inverted complex conjugates of x and y, A0 corresponds to 0 in the PTM sequence, A1 corresponds to 1 in the PTM sequence, a length of the PTM sequence is 2^{M+1}, and M is an integer greater than 0.

3. The apparatus according to claim 2, wherein in response to M=1, the sequences for target sensing are S_{Vm11} and S_{Hm12}, wherein S_{Vm11} and S_{Hm12} are:
S_{Vm11}=[x,−\tilde{y},−\tilde{y},−x,−\tilde{y},−x,x,−\tilde{y}]; and
S_{Hm12}=[y,\tilde{x},\tilde{x},−y,\tilde{x},−y,y,\tilde{x}].

4. The apparatus according to claim 2, wherein in response to M=2, the sequences for target sensing are S_{Vm21} and S_{Hm22}, wherein S_{Vm21} and S_{Hm22} are:
S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and
S_{Hm22}=[y,\tilde{x},\tilde{x},−y,\tilde{x},−y,y,\tilde{x},\tilde{x},−y,y,\tilde{x},y,\tilde{x},\tilde{x},−y].

5. The apparatus according to claim 2, wherein in response to M=3, the sequences for target sensing are S_{Vm31} and S_{Hm32}, wherein S_{Vm31} and S_{Hm32} are:
S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and
S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

6. The apparatus according to claim 2, wherein a sequence length of the binary sequence pair includes any one of the following: 256 bits, 512 bits, 1024 bits, and 2048 bits.

7. The apparatus according to claim 2, wherein a sequence length of the binary sequence pair is the 256 bits, sequences corresponding to the binary sequence pair are:
Sn2561 and Sn2562, wherein
Sn2561=[−1 −1 −1 −1 −1 −1 1 −1 1 −1 −1 −1 1 −1 1 1 1 1 1 1 1 1 −1 1 −1 1 −1 −1 1 −1 1 −1 −1 −1 1 1 1 1 −1 1 −1 1 −1 −1 −1 −1 1 −1 1 −1 −1 −1 1 1 −1 −1 −1 −1 1 1 −1 1 −1 1 −1 1 −1 −1 −1 1 −1 1 1 1 −1 1 −1 −1 −1 −1 1 1 −1 1 1 1 −1 1 1 1 −1 −1 1 1 1 −1 −1 1 1 −1 1 1 −1 −1 1 −1 1 1 −1 −1 1 1 −1 −1 −1 −1 1 1 −1 −1 1 1 −1 1 1 −1 −1 1 −1 −1 −1 1 1 −1 −1 1 −1 −1 −1 −1 −1 −1 1 1 −1 −1 1 −1 −1 1 −1 −1 1 −1 1 −1 1 −1 −1 1 1 −1 −1 −1 −1 −1 1 −1 1 −1 1 −1 −1 −1 1 −1 −1 −1 1 1 −1 1 −1 1 −1 1 1 −1 −1 −1 1 −1 −1 1 1 1 1 −1 1 1 −1 1 −1 1 1 −1 1 −1 1 −1 −1 1 1 1 −1 −1 −1 −1 1 −1 −1 1 −1 1 1 −1 1 1 −1 1 1 1 1 1 1 1 1 1 1 −1 −1 −1 −1 −1 1 1 −1 1 1 1 1 1 1 1 −1 1]; and
Sn2562=[1 −1 1 1 −1 1 1 1 1 −1 −1 −1 −1 1 1 −1 1 −1 1 1 −1 1 −1 −1 1 −1 −1 −1 −1 −1 −1 −1 1 1 −1 −1 −1 −1 −1 −1 1 1 −1 1 1 1 1 1 1 −1 1 −1 1 1 −1 −1 1 −1 1 1 −1 −1 1 1 −1 1 −1 1 −1 −1 −1 1 −1 1 1 −1 −1 1 1 −1 1 −1 1 1 1 −1 1 −1 −1 1 −1 −1 1 1 1 −1 −1 1 1 1 1 1 −1 −1 1 −1 1 1 1 −1 −1 −1 1 1 1 −1 −1 −1 1 −1 −1 −1 −1 1 1 −1 −1 1 1 −1 1 −1 1 1 1 1 −1 −1 1 −1 1 1 1 1 1 −1 −1 −1 −1 1 −1 −1 −1 −1 1 1 1 1 −1 −1 −1 1 1 1 1 1 −1 −1 −1 −1 1 1 1 1 1 1 −1 1 −1 −1 1 1 1 −1 1 −1 1 −1 1 1 −1 −1 −1 1 1 −1 1 1 1 −1 1 1 1 1 −1 1 −1 −1 −1 −1 1 −1 1 −1 −1 −1 1 1 1 −1 −1 −1 1 −1 −1 −1 1 1 1 −1 1 1 −1 −1 1 1 −1 1 −1 1 1 1 −1 1 −1 1 1 1 1 1 1 −1 −1 1 1 −1].

8. An apparatus, comprising:
a memory, storing computer instructions; and
a processor, configured to execute the computer instructions to cause the processor to:
receive a physical layer protocol data unit (PPDU), wherein the PPDU includes a training field, and the training field includes a sequence for target sensing; and
perform target sensing based on the sequence for target sensing.

9. The apparatus according to claim 8, wherein the sequence for target sensing is obtained based on a binary sequence pair, an Alamouti matrix, and a Prouhet-Thue-Morse PTM sequence, wherein the Alamouti matrix includes:
$$A 0 = [ \begin{matrix}x , - \tilde{y} \\ y , \tilde{x}\end{matrix} ] and A 1 = [ \begin{matrix}- \tilde{y} , - x \\ \tilde{x} , - y\end{matrix} ] ,$$
wherein
in response to x and y being the binary sequence pair, and \tilde{x} and \tilde{y} are respectively inverted complex conjugates of x and y, A0 corresponds to 0 in the PTM sequence, A1 corresponds to 1 in the PTM sequence, a length of the PTM sequence is 2^{M+1}, and M is an integer greater than 0.

10. The apparatus according to claim 9, wherein in response to M=1, the sequences for target sensing are S_{Vm11} and S_{Hm12}, wherein S_{Vm11} and S_{Hm12} are:
S_{Vm11}=[x,−\tilde{y},−\tilde{y},−x,−\tilde{y},−x,x,−\tilde{y}]; and
S_{Hm12}=[y,\tilde{x},\tilde{x},−y,\tilde{x},−y,y,\tilde{x}]

11. The apparatus according to claim 9, wherein in response to M=2, the sequences for target sensing are S_{Vm21} and S_{Hm22}, wherein S_{Vm21} and S_{Hm22} are:
S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and
S_{Hm22}=[y,\tilde{x},\tilde{x},−y,\tilde{x},−y,y,\tilde{x},\tilde{x},−y,y,\tilde{x},y,\tilde{x},\tilde{x},−y].

12. The apparatus according to claim 9, wherein in response to M=3, the sequences for target sensing are S_{Vm31} and S_{Hm32}, wherein S_{Vm31} and S_{Hm32} are:
S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and
S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

13. The apparatus according to claim 9, wherein a sequence length of the binary sequence pair includes any one of the following: 256 bits, 512 bits, 1024 bits, and 2048 bits.

14. The apparatus according to claim 9, wherein a sequence length of the binary sequence pair is the 256 bits, sequences corresponding to the binary sequence pair are:
Sn2561 and Sn2562, wherein
Sn2561=[−1 −1 −1 −1 −1 −1 1 −1 1 −1 −1 −1 1 −1 1 1 1 1 1 1 1 1 −1 1 −1 1 −1 −1 1 −1 1 −1 −1 −1 1 1 1 1 −1 1 −1 1 −1 −1 −1 −1 1 −1 1 −1 −1 −1 1 1 −1 −1 −1 −1 1 1 −1 1 −1 1 −1 1 −1 −1 −1 1 −1 1 1 1 −1 1 −1 −1 −1 −1 1 1 −1 1 1 1 −1 1 1 1 −1 −1 1 1 1 −1 −1 1 1 −1 1 1 −1 −1 1 −1 1 1 −1 −1 1 1 −1 −1 −1 −1 1 1 −1 −1 1 1 −1 1 1 −1 −1 1 −1 −1 −1 1 1 −1 −1 1 −1 −1 −1 −1 −1 −1 1 1 −1 −1 1 −1 −1 1 −1 −1 1 −1 1 −1 1 −1 −1 1 1 −1 −1 −1 −1 −1 1 −1 1 −1 1 −1 −1 −1 1 −1 −1 −1 1 1 −1 1 −1 1 −1 1 1 −1 −1 −1 1 −1 −1 1 1 1 1 −1 1 1 −1 1 −1 1 1 −1 1 −1 1 −1 −1 1 1 1 −1 −1 −1 −1 1 −1 −1 1 −1 1 1 −1 1 1 −1 1 1 1 1 1 1 1 1 1 1 −1 −1 −1 −1 −1 1 1 −1 1 1 1 1 1 1 1 −1 1]; and
Sn2562=[1 −1 1 1 −1 1 1 1 1 −1 −1 −1 −1 1 1 −1 1 −1 1 1 −1 1 −1 −1 1 −1 −1 −1 −1 −1 −1 −1 1 1 −1 −1 −1 −1 −1 −1 1 1 −1 1 1 1 1 1 1 −1 1 −1 1 1 −1 −1 1 −1 1 1 −1 −1 1 1 −1 1 −1 1 −1 −1 −1 1 −1 1 1 −1 −1 1 1 −1 1 −1 1 1 1 −1 1 −1 −1 1 −1 −1 1 1 1 −1 −1 1 1 1 1 1 −1 −1 1 −1 1 1 1 −1 −1 −1 1 1 1 −1 −1 −1 1 −1 −1 −1 −1 1 1 −1 −1 1 1 −1 1 −1 1 1 1 1 −1 −1 1 −1 1 1 1 1 1 −1 −1 −1 −1 1 −1 −1 −1 −1 1 1 1 1 −1 −1 −1 1 1 1 1 1 −1 −1 −1 −1 1 1 1 1 1 1 −1 1 −1 −1 1 1 1 −1 1 −1 1 −1 1 1 −1 −1 −1 1 1 −1 1 1 1 −1 1 1 1 1 −1 1 −1 −1 −1 −1 1 −1 1 −1 −1 −1 1 1 1 −1 −1 −1 1 −1 −1 −1 1 1 1 −1 1 1 −1 −1 1 1 −1 1 −1 1 1 1 −1 1 −1 1 1 1 1 1 1 −1 −1 1 1 −1].

15. A chip system, comprising:
a memory, storing computer instructions; and
a processor, configured to execute the computer instructions to cause the processor to:
generate a physical layer protocol data unit (PPDU), wherein the PPDU includes a training field, and the training field includes a sequence for target sensing; and
send the PPDU.

16. The chip system according to claim 15, wherein the sequence for target sensing is obtained based on a binary sequence pair, an Alamouti matrix, and a Prouhet-Thue-Morse PTM sequence, wherein the Alamouti matrix includes:
$$A 0 = [ \begin{matrix}x , - \tilde{y} \\ y , \tilde{x}\end{matrix} ] and A 1 = [ \begin{matrix}- \tilde{y} , - x \\ \tilde{x} , - y\end{matrix} ] ,$$
wherein
in response to x and y being the binary sequence pair, \tilde{x} and \tilde{y} are respectively inverted complex conjugates of x and y, A0 corresponds to 0 in the PTM sequence, A1 corresponds to 1 in the PTM sequence, a length of the PTM sequence is 2^{M+1}, and M is an integer greater than 0.

17. The chip system according to claim 16, wherein in response to M=1, the sequences for target sensing are S_{Vm11} and S_{Hm12}, wherein S_{Vm11} and S_{Hm12} are:
S_{Vm11}=[x,−\tilde{y},−\tilde{y},−x,−\tilde{y},−x,x,−\tilde{y}]; and
S_{Hm12}=[y,\tilde{x},\tilde{x},−y,\tilde{x},−y,y,\tilde{x}].

18. The chip system according to claim 16, wherein in response to M=2, the sequences for target sensing are S_{Vm21} and S_{Hm22}, wherein S_{Vm21} and S_{Hm22} are:
S_{Vm21}=[x,−\tilde{y},−\tilde{y},−x,−\tilde{y},−x,x,−\tilde{y},−\tilde{y},−x,x,−\tilde{y},x,−\tilde{y},−\tilde{y},−x]; and
S_{Hm22}=[y,\tilde{x},\tilde{x},−y,\tilde{x},−y,y,\tilde{x},\tilde{x},−y,y,\tilde{x},y,\tilde{x},\tilde{x},−y].

19. The chip system according to claim 16, wherein in response to M=3, the sequences for target sensing are S_{Vm31} and S_{Hm32}, wherein S_{Vm31} and S_{Hm32} are:
S_{Vm31}=[x,−\tilde{y},−\tilde{y},−x,−\tilde{y},−x,x,−\tilde{y},−\tilde{y},−x,x,−\tilde{y},x,−\tilde{y},−\tilde{y},−x,−\tilde{y},−x,x,−\tilde{y},x,−\tilde{y},−\tilde{y},−x,x,−\tilde{y},−\tilde{y},−x,−\tilde{y},−x,x,−\tilde{y}]; and
S_{Hm32}=[y,\tilde{x},\tilde{x},−y,\tilde{x},−y,y,\tilde{x},\tilde{x},−y,y,\tilde{x},y,\tilde{x},\tilde{x},−y,\tilde{x},−y,y,\tilde{x},y,\tilde{x},\tilde{x},−y,y,\tilde{x},\tilde{x},−y,\tilde{x},−y,y,\tilde{x}].

20. The chip system according to claim 16, wherein a sequence length of the binary sequence pair includes any one of the following: 256 bits, 512 bits, 1024 bits, and 2048 bits.
